(19) United States
(12) Patent Application Publication
(10) Pub. No.: US 2022/0213712 A1
(43) Pub. Date: Jul. 7, 2022

(54) STRUCTURE REINFORCING MATERIAL, METHOD FOR MANUFACTURING REINFORCING MATERIAL, AND METHOD FOR MANUFACTURING STRUCTURE

(71) Applicant: Naofumi Takemoto, Tokyo (JP)

(72) Inventor: Naofumi Takemoto, Tokyo (JP)

(21) Appl. No.: 17/605,189

(22) PCT Filed: Mar. 23, 2020
(86) PCT No.: PCT/JP2020/012802

§ 371 Date: Oct. 20, 2021

(30) Foreign Application Priority Data
Apr. 26, 2019 (JP) 2019-086764

(51) Int. Cl. E04H 12/02; B60R 19/18; H01Q 1/12; B29C 70/02; B64C 3/24

(52) U.S. Cl. CPC E04H 12/02; B60R 19/18; H01Q 1/1242; B29K 2475/02; B64C 3/24; B60R 2019/1853; B29C 70/025

(57) ABSTRACT

[Problem]

To increase rigidity.

[Solution]

Provided is a structure including a main body portion, a plurality of reinforcement members arranged on the main body portion, each of the reinforcement members including a base material formed of resin or metal. Provided is a manufacturing method of a structure which includes a main body portion having a hollow configuration surrounding an internal space thereof. The manufacturing method includes a preparation step of preparing a plurality of reinforcement members each including at least a base material formed of resin or metal, a carrying-in step of carrying the plurality of reinforcement members into the internal space from an opening arranged at the main body portion, and a step of arranging a fixing portion which fixes the plurality of reinforcement members into the main body portion.

### FIELD

The present invention relates to a structure, a reinforcement member, a reinforcement member manufacturing method, and a structure manufacturing method.

### BACKGROUND

A column-shaped structure is used in various use applications such as an antenna support pole for supporting an antenna in a base station of a mobile phone or the like, a power pole, a telephone pole, and a street lamp pole. An antenna in a base station of a mobile phone or the like is fixed to a structure called an antenna support pole (e.g., see Patent Document 1). Conventionally, there has been known a structure in which rigidity is increased by filling reinforcement materials such as polystyrene foam into a cylinder having an antenna mounting portion (e.g., see Patent Document 2).

### LIST OF DOCUMENTS

### Patent Documents

Patent Document 1: Japanese Patent Application Publication No. 2005-318077
Patent Document 2: Japanese Patent Application Publication No. H08-316713

### SUMMARY

### Technical Problem

In order to cope with an increase in the load applied to the structure, it is preferable to increase the rigidity of the structure without further change of the structure.

### Solution to Problem

According to an aspect of the present invention, a structure is provided. The structure may include a main body portion. The structure may include a plurality of reinforcement members arranged in the main body portion. Each of the reinforcement members may include a base material formed of resin or metal. Each of the reinforcement members may include the base material formed of fiber reinforced resin. Each of the reinforcement members may include the base material formed of fiber reinforced resin, and a coating layer which is formed of polyurea resin and which covers an outer surface of the base material. Each of the reinforcement members may include the base material formed of foamed synthetic resin, and a coating layer which is formed of polyurea resin and which covers an outer surface of the base material.

The main body portion may include at least one fixing portion which fixes the plurality of reinforcement members into the main body portion.

The main body portion may have a hollow configuration surrounding an internal space thereof. The plurality of reinforcement members may be arranged at the internal space.

The plurality of reinforcement members may include reinforcement members having different sizes.

The plurality of reinforcement members may be arranged in a plurality of layers in the main body portion.

The fixing portion may include a filler material. The filler material is filled in at least a part of the inside of the hollow configuration so as to be in contact with at least some reinforcement members among the plurality of reinforcement members and an inner surface of the hollow configuration.

The internal space may be separated into a plurality of regions by the filler material.

Sizes of the plurality of arranged reinforcement members may be different in correspondence to the separated regions.

The main body portion may have a hollow configuration surrounding an internal space thereof. The plurality of reinforcement members may be arranged at the internal space. The main body portion may include at least one fixing portion which fixes the plurality of reinforcement members into the main body portion. The internal space may be separated into a plurality of regions by the fixing portion. Elasticity of the coating layers of the plurality of arranged reinforcement members may be different in correspondence to the separated regions.

The filler material may include polyurea resin.

The main body portion may have a hollow configuration surrounding an internal space thereof. The plurality of reinforcement members may be arranged at the internal space. The main body portion may include at least one fixing portion which fixes the plurality of reinforcement members into the main body portion. The fixing portion may include a filler material which is filled in at least a part of the inside of the hollow configuration so as to be in contact with at least some reinforcement members among the plurality of reinforcement members and an inner surface of the hollow configuration. The filler material may include polyurea resin. The polyurea resin included in the filler material may have higher viscosity than polyurea resin in the coating layer.

The fixing portion may include a connection portion and an extension portion. The connection portion may have a side surface connected to an inner surface of the hollow configuration. The extension portion may extend from a main surface of the connection portion along an extension direction of the hollow configuration.

The main body portion may include a cover portion which closes an opening.

The main body portion may include at least one material selected from a group consisting of metal, ceramic, wood, and resin. A foamed synthetic resin may be arranged at the internal space. The plurality of reinforcement members may be embedded in the foamed synthetic resin at the internal space.

The plurality of reinforcement members may be embedded in the material of the main body portion.

The material of the main body portion may be resin or concrete.

Each of the reinforcement members may have a spherical shape, a polyhedron shape, or a columnar shape.

The main body portion may include a cylindrical portion as the hollow configuration. The plurality of reinforcement members may be arranged in the cylindrical portion. The fixing portion may fix the plurality of reinforcement members into the cylindrical portion.

Each of the reinforcement members may have a spherical shape. An inner diameter of the cylindrical portion may not be less than 2 times and not be more than 20 times a diameter of each of the reinforcement members.

The plurality of reinforcement members may be arranged in a plurality of layers in an axial direction of the cylindrical portion.

The fixing portion may include a filler material which is filled in at least a part of the inside of the cylindrical portion so as to be in contact with at least some reinforcement members among the plurality of reinforcement members and an inner surface of the cylindrical portion.

The fixing portion may include the filler material at a plurality of positions spaced apart from each other in an axial direction of the cylindrical portion.

The plurality of reinforcement members may be arranged in a partial region at a base end in an axial direction of the cylindrical portion.

The cylindrical portion may be configured such that a plurality of cylinders communicate with each other. The plurality of reinforcement members may be arranged in a partial region at a base end of each of the cylinders in an axial direction of the cylindrical portion.

The cylindrical portion may be configured such that a plurality of cylinders communicate with each other. Each of the cylinders may have a flange portion on at least one end. The flange portions of the adjacent cylinders are connected to each other. A rib may be arranged as being connected between a main surface of the flange portion and a side surface of the cylindrical portion. An external reinforcement portion may be arranged on an outer surface of the cylindrical portion so as to cover a pair of the connected flange portions and the ribs each corresponding thereto. The external reinforcement portion may be formed of polyurea resin.

The fixing portion may include a filler material. The filler material may be filled in at least a part of the inside of the cylindrical portion so as to be in contact with at least some reinforcement members among the plurality of reinforcement members and an inner surface of the cylindrical portion. The filler material may include polyurea resin having higher viscosity than polyurea resin applied on the outer surface of the cylindrical portion.

The structure may be an antenna support pole which supports an antenna. The structure may be a power pole which supports a power transmission line. The structure may be a telephone pole which supports a communication line. The structure may be a street lamp pole to which a street lamp is attached.

The structure may be a pallet on which an article is placed. The structure may be a box body having a space therein. The structure may be an airframe of a manned or unmanned aircraft. The structure may be a component of a vehicle. The structure may be a scaffold plank for construction.

The structure may be a panel as a building material. The structure may further include a fastening portion. One end of the fastening portion may be embedded in the main body portion. The other end of the fastening portion may be exposed.

The structure may be an impact absorbing member, a corrosion inhibitor, or a thermal insulator.

The structure may be a pipe body to be inserted as a new pipe into an aged existing pipe. The structure may be a container to be used as a packaging container. The structure may be a rail tie for railroad.

According to another aspect of the present invention, a reinforcement member is provided. A plurality of the reinforcement members may be arranged in a structure so as to reinforce the structure. The reinforcement member may include a base material formed of resin or metal. The reinforcement member may include the base material formed of fiber reinforced resin. The reinforcement member may further include a coating layer which is formed of polyurea resin and which covers an outer surface of the base material. The reinforcement member may include the base material formed of foamed synthetic resin, and a coating layer formed of polyurea resin. The coating layer may cover an outer surface of the base material.

The reinforcement member may have a spherical shape. The reinforcement member may have a polyhedron shape or a columnar shape.

A foaming magnification A of the foamed synthetic resin in the base material and a thickness T1 of the coating layer may satisfy (A/20)−1≤T1≤(A/20)+1 [mm].

According to another aspect of the present invention, a manufacturing method of a reinforcement member is provided as a plurality of reinforcement members being arranged in a structure so as to reinforce the structure. The manufacturing method of the reinforcement member may include a molding step of molding a base material formed of foamed synthetic resin into a spherical shape, a polyhedral shape, or a columnar shape. In the molding step, the base material formed of fiber reinforced resin may be molded into a spherical shape, a polyhedral shape, or a columnar shape. The manufacturing method may further include an injecting step of injecting a coating material of polyurea resin onto a surface of the molded base material. In the molding step, the base material formed of foamed synthetic resin may be formed into a spherical shape, a polyhedral shape, or a columnar shape. Further, the base material may be changed in size. In the molding step, the maximum size of the base material formed of fiber reinforced resin (the diameter when the base material is spherical) may be 10 mm or larger. The maximum size of the base material may be not less than 1 time and not more than 20 times the maximum size of a cross-section of the hollow configuration of the structure sectioned in a direction perpendicular to the axial direction. The manufacturing method may further include an injecting step of injecting a coating material of polyurea resin onto a surface of the molded base material.

A thickness of the coating layer to be formed on a surface of the base material in the injecting step may be set in accordance with a foaming magnification of the foamed synthetic resin in the base material. The thickness T1 of the coating layer may be set to satisfy (A/20)−1≤T1≤(A/20)+1 [mm], while A represents the foaming magnification of the foamed synthetic resin in the base material.

In another aspect of the present invention, a manufacturing method of a structure is provided. The structure may have a hollow configuration surrounding an internal space thereof. The manufacturing method may include a preparation step, a carrying-in step, and a step of arranging a fixing portion. In the preparation step, a plurality of reinforcement members may be prepared. Each reinforcement member may include at least a base material formed of resin or metal. Each reinforcement member may include a base material formed of foamed synthetic resin, and a coating layer formed of polyurea resin. The coating layer may cover an outer surface of the base material. In a carrying-in step, the plurality of reinforcement members may be carried into the internal space from an opening arranged at the main body portion. In a step of arranging a fixing portion, the fixing portion which fixes the plurality of reinforcement members may be fixed into the main body portion. Each of the reinforcement members may include the base material formed of fiber reinforced resin. Each of the reinforcement members may include the base material formed of fiber reinforced resin, and a coating layer which is formed of polyurea resin and which covers an outer surface of the base material. Each of the reinforcement members may include the base material formed of foamed synthetic resin, and a coating layer which is formed of polyurea resin and which covers an outer surface of the base material.

The manufacturing method may further include a pressing step of pressing the plurality of reinforcement members into the internal space. After the pressing step, the plurality of reinforcement members may be fixed into the main body portion by the fixing portion.

The step of arranging the fixing portion may include a filling step of filling at least a part of the internal space with a filler material as the fixing portion.

In the carrying-in step, the reinforcement members having different sizes may be carried into the internal space.

The plurality of reinforcement members may be arranged in a plurality of layers in the main body portion. The carrying-in step may be performed before and after the step of arranging the fixing portion, respectively. The internal space may be separated into a plurality of regions by the fixing portion. The carrying-in step may be performed before and after the filling step, respectively. The internal space may be separated into a plurality of regions by the filler material. The carrying-in step and the filling step may be repeated plural times. In each of plural times of the carrying-in steps, sizes of the plurality of reinforcement members may be different in correspondence to the separated regions. In each of the plural times of carrying-in steps, elasticity of the coating layers of the plurality of arranged reinforcement members may be different in correspondence to the separated regions.

The fixing portion may include a connection portion having a side surface connected to an inner surface of the hollow configuration, and an extension portion extending from a main surface of the connection portion along an extension direction of the hollow configuration. In the carrying-in step, the plurality of reinforcement members may be carried into a space between the extension portion and an inner surface of the main body portion.

The filler material may include polyurea resin. Each of the reinforcement members may have a spherical shape, a polyhedron shape, or a columnar shape.

The main body portion may include a cylindrical portion as the hollow configuration. In the carrying-in step, the plurality of reinforcement members may be arranged in the cylindrical portion. The fixing portion may fix the plurality of reinforcement members into the cylindrical portion.

Each of the reinforcement members may have a spherical shape. An inner diameter of the cylindrical portion may not be less than 2 times and not be more than 20 times a diameter of the reinforcement member.

The cylindrical portion may be configured such that a plurality of cylinders communicate with each other. Each of the cylinders may have a flange portion on at least one end. The flange portions of the adjacent cylinders may be connected to each other. A rib may be arranged as being connected between a main surface of the flange portion and a side surface of the cylindrical portion. The manufacturing method may further include an external reinforcement portion forming step of forming an external reinforcement portion on an outer surface of the cylindrical portion so as to cover a pair of the connected flange portions and the ribs. The external reinforcement portion forming step may further include an application step of applying polyurea resin on the outer surface of the cylindrical portion so as to cover a pair of the connected flange portions and the ribs.

The plurality of reinforcement members may be arranged in a partial region at a base end in an axial direction of the cylindrical portion.

The cylindrical portion may be configured such that a plurality of cylinders communicate with each other. The plurality of reinforcement members may be arranged in a partial region at a base end of each of the cylinders in an axial direction of the cylindrical portion.

According to another aspect of the present invention, a manufacturing method of a structure which includes a main body portion is provided. The manufacturing method may include a preparation step and a step of forming the main body portion. In the preparation step, a plurality of reinforcement members may be prepared. Each of the reinforcement members may include a base material formed of resin. In the step of forming the main body portion, the main body portion may be formed by molding a material of the main body portion such that the plurality of reinforcement members are embedded therein. Each of the reinforcement members may include the base material formed of fiber reinforced resin. Each of the reinforcement members may include the base material formed of fiber reinforced resin, and a coating layer which is formed of polyurea resin and which covers an outer surface of the base material. Each of the reinforcement members may include the base material formed of foamed synthetic resin, and a coating layer which is formed of polyurea resin and which covers an outer surface of the base material.

The material of the main body portion may be resin or concrete.

The material of the main body portion may be foamed synthetic resin for the main body portion. The step of forming the main body portion may include a step of molding the foamed synthetic resin for the main body portion such that the plurality of reinforcement members are embedded therein. The manufacturing method may further include a main body portion application step of applying polyurea resin to an outside of the foamed synthetic resin for the main body portion.

It should be noted that the summary of the present invention described above does not list all of the necessary features of the present invention. The present invention may also include a sub-combination of the features described above.

### BRIEF DESCRIPTION OF DRAWINGS

FIG. 1 is a side view showing an example of an antenna support pole 1 in a first embodiment of the present invention.

FIG. 2 shows an example of a flange portion 14 and ribs 15 arranged at one end of a cylinder 12.

FIG. 3 is a sectional view showing as enlarging a part of a cylindrical portion 10 in the antenna support pole 1 of FIG. 1.

FIG. 4A is a sectional view showing an example of a reinforcement member 20 arranged in the cylindrical portion 10.

FIG. 4B is a view showing the relationship between the foaming magnification of foamed synthetic resin which forms a base material 22 and a thickness T1 of a coating layer 24.

FIG. 4C is a flowchart showing an example of a manufacturing process of the reinforcement member 20.

FIG. 4D is a sectional view showing another example of the reinforcement member 20 arranged in the cylindrical portion 10.

FIG. 4D is a sectional view showing another example of the reinforcement member 20 arranged in the cylindrical portion 10.

FIG. 5 is a plan view showing an arrangement example of the reinforcement members 20 in the cylinder 12.

FIG. 6 is a view showing an example of a layer configuration of the reinforcement members 20 in the cylinder 12.

FIG. 7 is a plan view showing an arrangement example of the reinforcement members 20 in a cylinder 11.

FIG. 8 is a plan view showing an arrangement example of the reinforcement members 20 in a cylinder 13.

FIG. 9 is a partial sectional view showing an example of the antenna support pole 1 in a second embodiment of the present invention.

FIG. 10 is a partial sectional view showing an example of the antenna support pole 1 in a third embodiment of the present invention.

FIG. 11 is a partial sectional view showing an example of the antenna support pole 1 in a fourth embodiment of the present invention.

FIG. 12 is a partial sectional view showing an example of the antenna support pole 1 in a fifth embodiment of the present invention.

FIG. 13 is a view showing an example of a manufacturing method of a structure of the present invention.

FIG. 14 is a view showing an example of a carrying-in device 90.

FIG. 15 is a partial sectional view showing an example of the antenna support pole 1 in a sixth embodiment of the present invention.

FIG. 16 is a partial sectional view showing an example of the antenna support pole 1 in a seventh embodiment of the present invention.

FIG. 17 is a sectional view showing an example of the antenna support pole 1 in an eighth embodiment of the present invention.

FIG. 18 is a view showing another example of the reinforcement member 20.

FIG. 19 is a view showing another example of the reinforcement member 20.

FIG. 20 is a view for explaining conditions of a simulation test.

FIG. 21 is a view showing a modification example of the antenna support pole 1.

FIG. 22 is a view showing a modification example of the antenna support pole 1.

FIG. 23 is a view showing a modification example of the antenna support pole 1.

FIG. 24 is a view showing a modification example of the antenna support pole 1.

FIG. 25 is a view showing an example of a power pole 4.

FIG. 26 is a view showing an example of a street lamp pole 6.

FIG. 27 is a perspective view showing an example of the structure 100 in a ninth embodiment of the present invention.

FIG. 28 is a sectional view showing an example of a cross-section of the structure 100 shown in FIG. 27.

FIG. 29 is a sectional view showing an example of the structure 100 in a tenth embodiment of the present invention.

FIG. 30 is a sectional view showing an example of the structure 100 in an eleventh embodiment of the present invention.

FIG. 31 is a sectional view showing an example of the structure 100 in a twelfth embodiment of the present invention.

FIG. 32 is a perspective view showing an example of a pallet 210 in a thirteenth embodiment of the present invention.

FIG. 33 is a sectional view showing an example of a cross-section of the pallet 210 shown in FIG. 32.

FIG. 34 is a perspective view showing an example of a box body 220 in a fourteenth embodiment of the present invention.

FIG. 35 is a sectional view showing an example of the box body 220 shown in FIG. 34.

FIG. 36 is a view showing an example of an airframe 230 of an aircraft in a fifteenth embodiment of the present invention.

FIG. 37 is a view showing an example of a component of a vehicle in a sixteenth embodiment of the present invention.

FIG. 38 is a view showing an example of a scaffold plank 250 for construction in a seventeenth embodiment of the present invention.

FIG. 39 is a view showing an example of a panel 260 as a building material in an eighteenth embodiment of the present invention.

FIG. 40 is a view showing an example of an impact absorbing member 270 in a nineteenth embodiment of the present invention.

FIG. 41 is a view showing another example of the impact absorbing member 270.

FIG. 42 is a sectional view showing an example of a pipe body 280 in a twentieth embodiment of the present invention.

FIG. 43 is a sectional view showing an example of a packaging container 300 in a twenty-first embodiment of the present invention.

FIG. 44 is a sectional view showing an example of a rail tie 410 in a twenty-second embodiment of the present invention.

### DETAILED DESCRIPTION

Hereinafter, the present invention will be described through embodiments of the invention. However, the following embodiments do not limit the invention according to the claims. Further, all the combinations of the features described in the embodiments are not necessarily essential to solutions of the present invention.

In this specification, when a structure is a support pole, one side in a direction parallel to the height direction of the support pole is referred to as “upper” and the other side is referred to as “lower”. One of two main surfaces of a layer or another member is referred to as an upper surface, and the other surface is referred to as a lower surface. The directions of “upper” and “lower” are not limited to the direction of gravity or the direction of attachment of the support pole.

In this specification, technical matters may be described by using orthogonal coordinate axes of an X axis, a Y axis, and a Z axis. In this specification, when the structure has a cylindrical portion, an axial direction of the cylindrical portion is defined as a Z axis, and a plane perpendicular to the Z axis is defined as an XY plane.

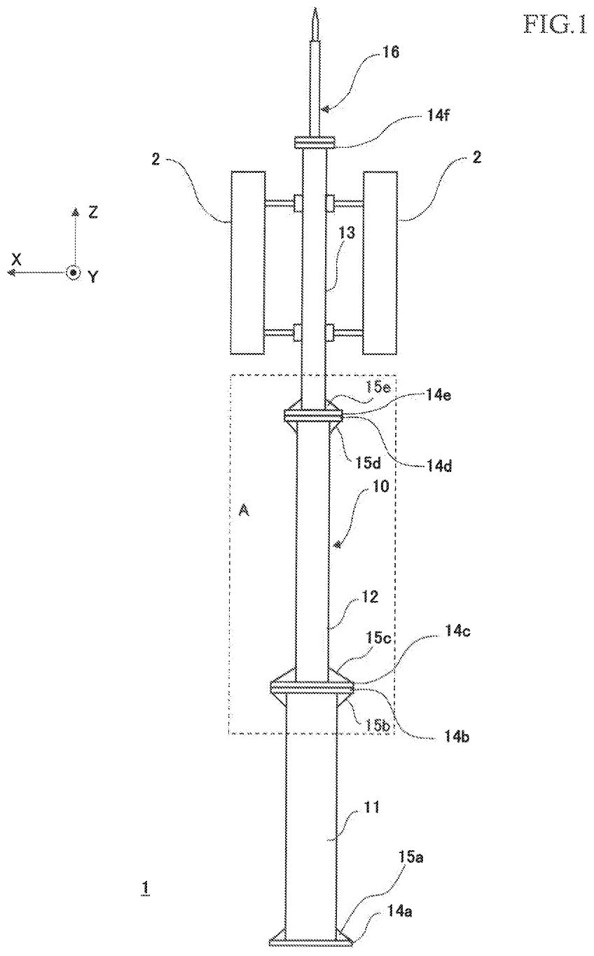

FIG. 1 is a side view showing an example of an antenna support pole 1 for antenna support in a first embodiment of the present invention. The antenna support pole 1 may be a column or a tower-like structure for installing an antenna 2. The antenna support pole 1 is an example of a column body which is the structure of the present invention. The antenna 2 may be an antenna for various types of communication such as a mobile phone, a wireless LAN, and a wireless sign. In one example, the antenna 2 may be an antenna for a fifth generation mobile communication system (5G). The antenna 2 may include both an antenna for a fourth generation mobile communication system (4G) and an antenna for 5G.

The antenna support pole 1 has rigidity to withstand the weight of the antenna 2. In particular, the antenna support pole 1 of the present embodiment may be formed by reinforcing an existing column body. The expansion of the antenna base station is approaching the limit, and there is the case in which an antenna is expanded by using an existing support pole in an existing antenna base station. In particular, the weight of an antenna for the fifth generation mobile communication system (5G) is heavy compared with the previous antenna weight. Therefore, when an antenna for 5G is added to an existing column body, it is desirable to further increase the rigidity of the antenna support pole 1 on which the antenna for 5G is to be installed. Here, the type of the antenna 2 is not limited to the cases described above. In the antenna support pole 1 of the present embodiment, a plurality of reinforcement members each including a base material formed of metal or resin are provided in a cylindrical portion constituting the pole to cope with an increase in weight due to an increase in the number of antennas 2 or the like.

The antenna support pole 1 includes a cylindrical portion 10 which supports the antenna 2. The cylindrical portion 10 is an example of a main body portion. The main body portion may have a hollow configuration in which an internal space is surrounded. In the present example, the main body portion includes the cylindrical portion 10 as the hollow configuration. In the present example, the cylindrical portion 10 is configured such that a plurality of cylinders (a cylinder 11 (first cylinder), a cylinder 12 (second cylinder), and a cylinder 13 (third cylinder)) communicate with each other. Each cylinder 11, 12, 13 includes a flange portion 14 on at least one end. The cylinder 11 may have a flange portion 14a on one end and a flange portion 14b on the other end. The cylinder 12 may have a flange portion 14c on one end and a flange portion 14d on the other end. The cylinder 13 may have a flange portion 14e on one end and a flange portion 14f on the other end.

The flange portions 14b, 14c of the adjacent cylinders 11, 12 are connected, and the flange portions 14d, 14e of the adjacent cylinders 12, 13 are connected. In this manner, the flange portions 14 of adjacent cylinders may be connected to each other to form the cylindrical portion 10. The cylinder 11 is arranged at the lowermost position (in a direction close to a base end of the cylindrical portion 10) among the plurality of cylinders, and the cylinder 12 and the cylinder 13 may be connected in this order upward from the cylinder 11 (toward a top end of the cylindrical portion 10). The cylinder 11 may have the largest inner diameter and the largest outer diameter among the plurality of cylinders, and the inner diameter and the outer diameter may decrease in the order of the cylinder 12 and the cylinder 13 as the cylinder is arranged on the upper side. Each of the cylinders 11, 12, 13 may have an inner diameter and an outer diameter constant in a predetermined range from one end to the other end.

Each of the cylinders 11, 12, 13 configuring the cylindrical portion 10 may be formed of metal such as steel, and may be further subjected to a surface treatment such as hot dip galvanizing. Here, the cylindrical portion 10 may be formed of fiber reinforced resin (FRP). The cylindrical portion 10 as the main body portion may include at least one material selected from the group consisting of metal, ceramic, wood, and resin.

The flange portion 14a arranged at a lower end of the cylinder 11 may be used when the antenna support pole 1 is attached to a structural object such as a building. Instead of the flange portion 14a, a separate mounting configuration may be arranged. A lightning rod 16 may be attached to a flange portion 14 arranged at an upper end of the cylinder 13.

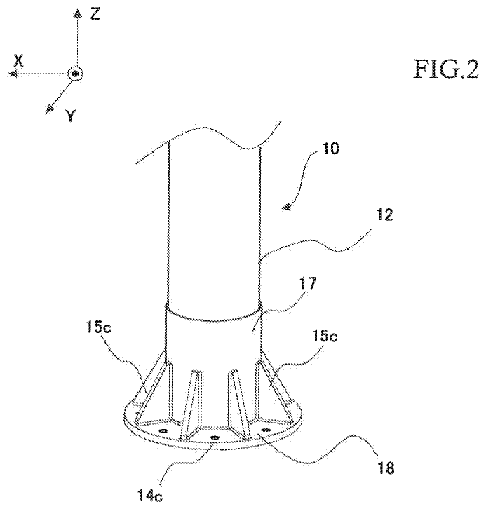

FIG. 2 shows an example of the flange portion 14 and ribs 15 arranged at one end of the cylinder 12. The flange portions 14 and the ribs 15 at the other cylinders 11, 13 may have the similar configuration. Ribs 15c extending in the axial direction may be arranged between a main surface 18 of each flange portion 14 (upper surface or lower surface) and a side surface 17 of the corresponding cylinder. The rigidity of the cylindrical portion 10 can be increased by the ribs 15c. A plurality of the ribs 15c may be arranged per one flange portion 14. The plurality of ribs 15c may be arranged to extend radially from the axis center in a top view. The top view refers to a view from the positive direction of the Z axis. The other flange portions 14 and ribs 15 may have the similar configuration. The main surface of each rib 15c may have a triangular shape.

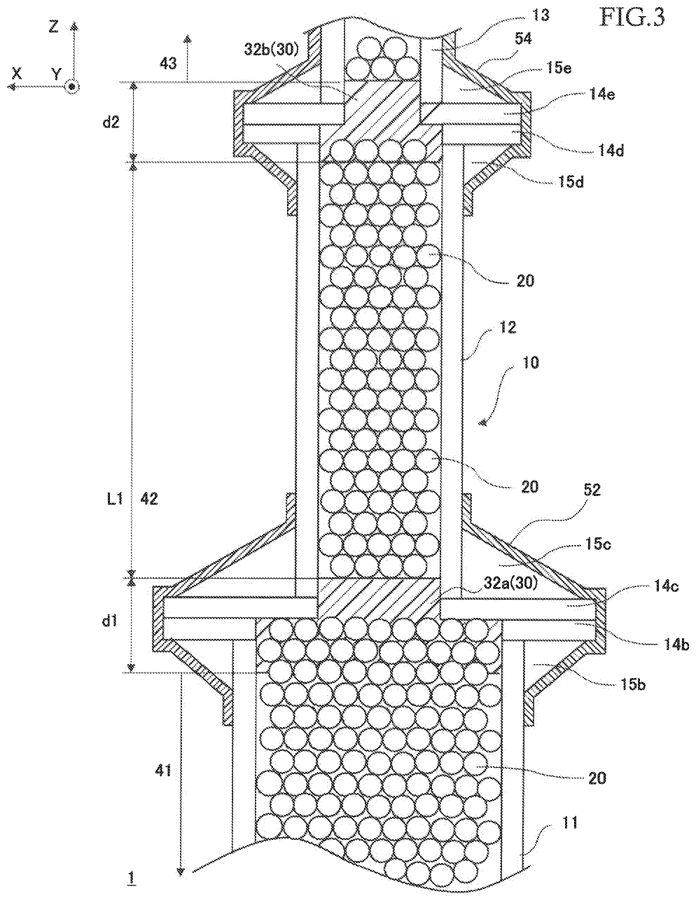

FIG. 3 is a conceptual view showing an enlarged cross-section of a part of the cylindrical portion 10 in the antenna support pole 1 of FIG. 1. FIG. 3 schematically shows a cross-section of the section A of FIG. 1 taken along the ZX plane. The antenna support pole 1 includes a plurality of reinforcement members 20 arranged in the cylindrical portion 10. In FIG. 3, the arrangement of the plurality of reinforcement members 20 in the cylindrical portion 10 is schematically shown. The plurality of reinforcement members 20 are arranged in the may body portion. As in the present example, when the main body portion has the hollow configuration in which the internal space is surrounded, the plurality of reinforcement members 20 are arranged at the internal space. In the present example, the plurality of reinforcement members 20 are arranged at the internal space which is surrounded by the cylindrical portion 10.

The main body portion of the antenna support pole 1 includes at least one fixing portion 30 which fixes the plurality of reinforcement members 20 into the main body portion. In the present example, the main body portion includes at least one fixing portion 30 which fixes the plurality of reinforcement members 20 into the cylindrical portion 10. In the present example, the fixing portion 30 includes a filler material 32. The filler material 32 is filled in at least a part of the inside of the hollow configuration so as to be in contact with at least some reinforcement members 20 among the plurality of reinforcement members 20 and the inner surface of the hollow configuration. In the present example, the filler material 32 is filled in at least a part of the inside of the cylindrical portion 10 so as to be in contact with at least some reinforcement members 20 among the plurality of reinforcement members 20 and the inner surface of the cylindrical portion 10.

In the present example, a plurality of the filler materials 32a, 32b are formed. The filler material 32a is in contact with the reinforcement members 20 arranged in the cylinder 11 and the inner surface of the cylinder 11. The filler material 32b is in contact with the reinforcement members 20 arranged in the cylinder 12 and the inner surface of the cylinder 12. Although not shown in FIG. 3, another filler material 32 in contact with the reinforcement members 20 arranged in the cylinder 13 and the inner surface of the cylinder 13 may also be arranged.

The filler material 32a may be arranged in the range of a thickness d1 in the axial direction of the cylindrical portion 10. The filler material 32b may be arranged in the range of a thickness d2 in the axial direction of the cylindrical portion 10. Thus, in the present example, each of the filler materials 32 is arranged at a part of the inside of the cylindrical portion 10. The filler material 32a and the filler material 32b may be spaced apart from each other by a length L1. In other words, the fixing portion 30 may include the filler materials 32 at a plurality of positions spaced apart from each other in the axial direction of the cylindrical portion 10. Thicknesses d1, d2 of the filler material 32a and the filler material 32b may be smaller than the spaced distance L1 therebetween, respectively. The thickness d1 and the thickness d2 may be the same or different.

In particular, it is preferable that the filler material 32a is arranged so as to be overlapped with a section where the pair of flange portions 14b, 14c are arranged in the axial direction of the cylindrical portion 10. Similarly, it is preferable that the filler material 32b is arranged so as to be overlapped with a section where the pair of flange portions 14d, 14e are arranged in the axial direction of the cylindrical portion 10. Since stresses are likely to be applied to the sections where the flange portions 14 and the ribs 15 are arranged, the rigidity of the cylindrical portion 10 can be increased particularly by arranging the filler materials 32a, 32b. However, the filler materials 32a, 32b may be arranged at positions different from the connecting positions of the cylinder 11 and the cylinder 12.

The filler material 32a and the filler material 32b separate the internal space of the hollow configuration into a plurality of regions. In the present example, the filler material 32a and the filler material 32b separate the internal space of the cylindrical portion 10 into a plurality of regions. The filler material 32a and the filler material 32b fill the space so as to surround the reinforcement members 20 in the cylindrical portion 10 in the range of the thickness d1 and the thickness d2, respectively. The inside of the cylindrical portion 10 is divided into a region 41, a region 42, and a region 43 in the axial direction of the cylindrical portion 10. The region 41 is a first region located below the position where the filler material 32a is arranged. The region 42 is a second region sandwiched between the position where the filler material 32a is arranged and the position where the filler material 32b is arranged. The region 43 is a third region 43 located above the position where the filler material 32b is arranged. The filler materials 32 may be formed of resin. In particular, the filler materials 32 may be formed of polyurea resin.

Polyurea resin is, for example, resin having urea bond formed by a chemical reaction between isocyanate and an amino group. As an example, polyurea resin is formed through a reaction between polyisocyanate and polyamine.

In the antenna support pole 1 of the present embodiment, an external reinforcement portion 52 is arranged on the outer surface of the cylindrical portion 10 so as to cover the pair of flange portions 14b, 14c connected to each other. The external reinforcement portion 52 may cover the ribs 15b, 15c as well as the flange portions 14b, 14c. The external reinforcement portion 52 may cover a part of the side surface of the cylinder 11 and a part of the side surface of the cylinder 12 in the Z-axis direction. Similarly, an external reinforcement portion 54 is arranged on the outer surface of the cylindrical portion 10 so as to cover the pair of flange portions 14d, 14e connected to each other. The external reinforcement portion 54 may cover the ribs 15d, 15e as well as the flange portions 14d, 14e. The external reinforcement portion 54 may cover a part of the side surface of the cylinder 12 and a part of the side surface of the cylinder 13 in the Z-axis direction. The external reinforcement portions 52, 54 may each be a protective film formed of polyurea resin.

The viscosity of polyurea resin forming the filler material 32 may be higher than that of polyurea resin contained in the external reinforcement portions 52, 54. Accordingly, the fluidity of the external reinforcement portions 52, 54 is suppressed, and the external reinforcement portions 52, 54 are easily formed in specific regions in the cylindrical portion 10. However, the present invention is not limited to this case, and depending on the use application, the viscosity of polyurea resin forming the filler material 32 may be lower than that of polyurea resin contained in the external reinforcement portions 52, 54. In one example, in order to enlarge the range in which the filler material 32 is filled in the cylindrical portion 10, the viscosity of polyurea resin used as the filler material 32 may be equal to or lower than that of polyurea resin contained in the external reinforcement portions 52, 54. Here, the external reinforcement portions 52, 54 each are not limited to a protective film formed of polyurea resin.

Each reinforcement member 20 may be spherical in shape. However, as will be described later, the shape of each reinforcement member 20 is not limited to a spherical shape. In this specification, the spherical shape is not limited to a true spherical shape, and includes a spherical shape and an ellipsoid exhibiting surface unevenness or sphericity caused by a production process. The plurality of reinforcement members 20 may be arranged in a plurality of layers in the axial direction (Z-axis direction) of the cylindrical portion 10, or may be arranged by being arbitrarily filled without forming layers.

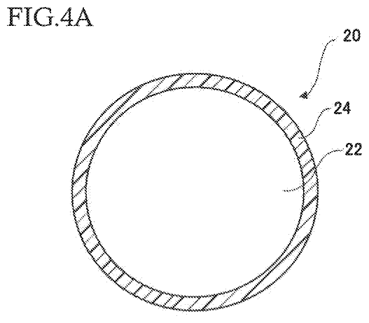

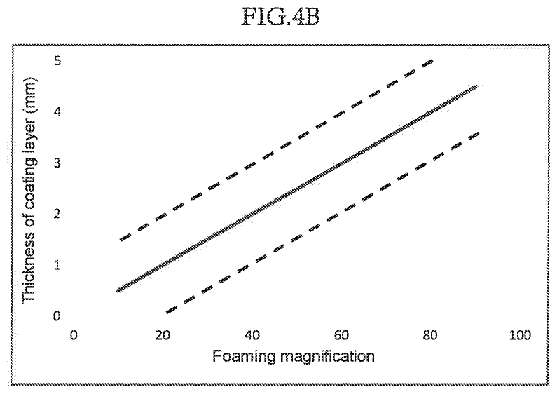

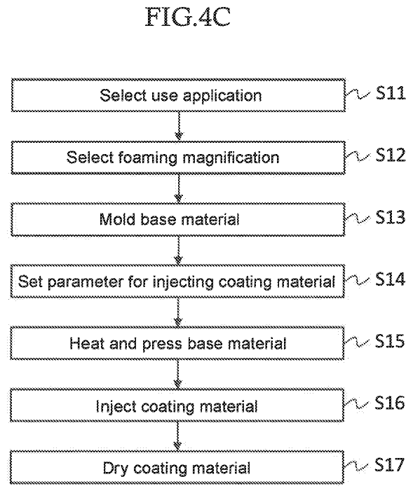

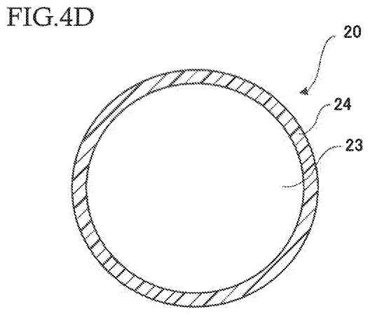

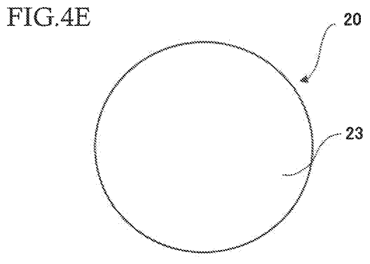

FIG. 4A is a sectional view showing an exemplary reinforcement member 20 arranged in the cylindrical portion 10. Each reinforcement member 20 includes a base material 22 and a coating layer 24 which covers the outer surface of the base material 22. The base material 22 may be spherical in shape. The thickness of the coating layer 24 is less than the diameter of the base material 22. In one example, the diameter of the base material 22 may be 10 mm or more, and the thickness of the coating layer 24 may be 0.5 mm or more and 6 mm or less. In one example, the diameter of the base material 22 is 40 mm, the thickness of the coating layer 24 is 4 mm, and the overall diameter of the reinforcement member 20 is 48 mm.

In the present example, the base material 22 is formed of foamed synthetic resin. As an example, synthetic resin forming the base material 22 is a polymer compound. As a more specific example, synthetic resin forming the base material 22 is formed of one or more materials selected from polystyrene, polyethylene, polypropylene, and polyurethane. Foamed synthetic resin refers to synthetic resin described above in which fine bubbles are dispersed.

In one example, the base material 22 is formed of foamed styrene (foamed polystyrene).

The coating layer 24 is arranged so as to cover the entire outer surface of the base material 22. The coating layer 24 is formed of polyurea resin. Polyurea resin is, for example, resin having urea bond formed by a chemical reaction between isocyanate and an amino group. As an example, polyurea resin is formed through a reaction between polyisocyanate and polyamine. In one example, as the content ratio of “diethyltoluenediamine” which is a constituent solution of an amine solution and “diphenylmethane diisocyanate” which is a constituent solution of an isocyanate solution increases, the hardness of polyurea resin increases and the elasticity thereof decreases. Thus, depending on the use application of the structure, the elasticity of the coating layer 24 of the reinforcement member 20 can be changed. Note that polyurea resin contained in the filler material 32 may have higher viscosity than polyurea resin in the coating layer 24. However, it is not limited thereto.

FIG. 4B is a view showing the relationship between the foaming magnification of the foamed synthetic resin which forms the base material 22 and a thickness T1 of the coating layer 24. In the present example, the thickness T1 of the coating layer 24 is determined according to the foaming magnification of the base material 22. The foaming magnification indicates an expansion ratio (volume ratio) when, for example, particles of synthetic resin (raw material beads) are expanded by heating with steam or the like. More specifically, in foamed synthetic resin having the foaming magnification of 50, air accounts for 98% of the total product (volume) and synthetic resin accounts for 2%. Generally, the foaming magnification and the strength of foamed synthetic resin are inversely proportional. For example, foamed synthetic resin having the foaming magnification of 30 has strength twice as high as that of foamed synthetic resin having the foaming magnification of 60, but has a volume of about half thereof.

The foaming magnification is selected according to the use application of the structure in which the reinforcement member 20 is used. Depending on the use application, the thickness that the base material 22 should have is determined. The foaming magnification is determined according to the strength of the base material 22.

The thickness T1 of the coating layer 24 is set so as to be substantially proportional to the foaming magnification. Normally, the thickness T1 of the coating layer 24 is about A/20 mm, where A denotes the foaming magnification. For example, in a normal cylindrical body, when the foaming magnification is 40, the thickness T1 of the coating layer 24 is preferably about 2 mm. In addition, when the foaming magnification is 60, the thickness T1 of the coating layer 24 is preferably about 3 mm. By making the thickness T1 of the coating layer 24 proportional to the foaming magnification A, the thickness T1 of the coating layer 24 is increased as the strength of the base material 22 is lowered, so that the strength of the entire structure can be maintained.

However, the thickness T1 of the coating layer 24 may be increased or decreased with respect to a normal thickness. As an example, the thickness T1 of the coating layer 24 is increased to increase the strength, and the thickness T1 of the coating layer 24 is decreased to reduce the cost. As an example, the thickness T1 of the coating layer 24 may be in the range indicated by dotted lines in FIG. 4B.

(A/20)−1≤T1≤(A/20)+1 [mm]

Note that the foaming magnification of foamed synthetic resin can be estimated from the material type of synthetic resin and the weight per unit volume of foamed synthetic resin. That is, the volume of synthetic resin before foaming is estimated from the weight per unit volume of foamed synthetic resin and the material of synthetic resin. Then, the foaming magnification is calculated from the estimated volume of the synthetic resin before foaming and the unit volume of foamed synthetic resin.

FIG. 4C is a flowchart showing an example of a manufacturing process of the reinforcement member 20. First, in an application selecting step S11, a use application of the structure (type of structure) in which the reinforcement member 20 is used is selected.

Next, in a foaming magnification selecting step S12, the foaming magnification of foamed synthetic resin used for the reinforcement member 20 is selected. The foaming magnification may be determined according to the use application of the structure selected in S11.

Next, in a base material molding step S13, the base material of foamed synthetic resin is molded into a predetermined shape. For example, the base material 22 formed of foamed synthetic resin is formed into a spherical shape, a polyhedral shape, or a columnar shape.

Next, in a parameter setting step S14, respective parameters for injecting a coating material are set. The parameters include, for example, the injection amount of the coating material per unit time with respect to the unit area of the base material 22.

In a heating-pressing step S15, the base material 22 may be heated and pressed. However, the heating-pressing step S15 may be omitted.

Next, in an injecting step S16, the coating material is injected onto the base material 22. In S16, it is preferable to inject the coating material onto the entire surface of each base material 22.

Next, in a drying step S17, the coating material is dried. Thus, the coating layer 24 is formed on the surface of the base material 22.

FIG. 4D is a sectional view showing another example of the reinforcement member 20 arranged in the cylindrical portion 10. In the example shown in FIGS. 1 to 4C, the reinforcement member 20 includes the base material 22 formed of foamed synthetic resin and the coating layer 24 which is formed of polyurea resin and which covers the outer surface of the base material 22. However, the present invention is not limited thereto.

In the example shown in FIG. 4D, each reinforcement member 20 includes a base material 23. In the present example, the base material 23 is formed of fiber reinforced resin (FRP). Specifically, the base material 23 may be formed of glass fiber reinforced resin (GFRP) or carbon fiber reinforced resin (CFRP). Glass fiber reinforced resin (GFPR) is obtained by consolidating glass fibers with polyester resin, vinyl ester resin, epoxy resin, phenolic resin, or other thermoplastic resin. Carbon fiber reinforced resin (CFRP) is obtained by consolidating carbon fibers with polyester resin, vinyl ester resin, epoxy resin, phenolic resin, or other thermoplastic resin. However, fiber reinforced resin (FRP) is not limited to glass fiber reinforced resin (GFRP) and carbon fiber reinforced resin (CFRP). For example, fiber reinforced resin (FRP) may be aramid fiber (Kevlar fiber) reinforced resin, polyethylene fiber (Dynema fiber) reinforced resin, zylon fiber reinforced resin, or boron fiber reinforced resin.

Each reinforcement member 20 may include the coating layer 24 which is formed of polyurea resin and which covers the outer surface of the base material 23. However, the reinforcement member 20 may not necessarily include the coating layer 24.

FIG. 4E is a sectional view showing another example of the reinforcement member 20 arranged in the cylindrical portion 10. In FIG. 4E, the reinforcement member 20 includes the base material 23 formed of fiber reinforced resin (FRP), but does not include the coating layer 24 formed of polyurea resin. Note that, in FIGS. 4D and 4E, a base material formed of metal may also be used instead of the base material 23 formed of fiber reinforced resin (FRP). However, from a viewpoint of specific gravity and the like, it is preferable to use the base material 23 formed of fiber reinforced resin (FRP) rather than metal.

The rigidity of the structure can be increased in the example using the reinforcement member 20 in which the base material 23 is formed of glass fiber reinforced resin (GFRP) or carbon fiber reinforced resin (CFRP) (FIG. 4D or FIG. 4E) compared with the case using the reinforcement member 20 in which the base material 22 is formed of foamed synthetic resin (FIG. 4A). In particular, in order to further enhance rigidity when the rigidity of the main body portion of the structure is relatively high, it is preferable to use the reinforcement member 20 in which the base material 23 is formed of glass fiber reinforced resin (GFRP) or carbon fiber reinforced resin (CFRP). On the other hand, when the rigidity of the main body portion of the structure is relatively low, the effect of increasing the rigidity is likely to be manifested even when the reinforcement member 20 in which the base material 22 is formed of foamed synthetic resin is used. Depending on the use application, the material of the base material can be selected.

In the manufacturing process of the reinforcement member 20 shown in FIG. 4D, S11, S12, and S15 in FIG. 4C are omitted. In the base material molding step S13 in FIG. 4C, the base material 23 of the fiber reinforced resin (FRP) is molded into a predetermined shape. For example, in the base material molding step S13, the base material 23 of the fiber reinforced resin FRP is molded into a spherical shape, a polyhedron shape, or a columnar shape. In the parameter setting step S14, respective parameters for injecting the coating material are set. Next, in the injecting step S16, the coating material is injected onto the base material 23. In S16, it is preferable to inject the coating material onto the entire surface of each base material 23. Next, in the drying step S17, the coating material is dried. Thus, the coating layer 24 is formed on the surface of the base material 23. On the other hand, in the manufacturing process of the reinforcement member 20 shown in FIG. 4E, S14, S16, and S17 are further omitted. Since the other steps are similar to the manufacturing process of the reinforcement member 20 shown in FIG. 4D, the description thereof will not be repeated.

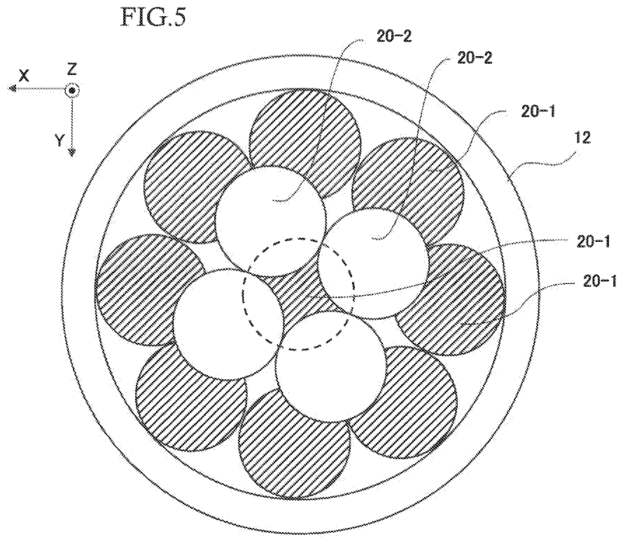

FIG. 5 is a plan view showing an arrangement example of the reinforcement members 20 in the cylinder 12. The plurality of reinforcement members 20 are arranged in a plurality of layers in the axial direction of the cylindrical portion 10. In FIG. 5, the inner diameter of the cylinder 12 is 180 mm, and the diameter of each reinforcement member 20 is 48 mm. In FIG. 5, a plurality of reinforcement members 20-1 configure a first layer, and a plurality of reinforcement members 20-2 configure a second layer. In the example of FIG. 5, a total of nine reinforcement members 20-1 configure the first layer. Specifically, in a top view, the first layer includes eight reinforcement members 20-1 located so that points of the respective reinforcement members 20-1 coincide with the apexes of a substantially regular octagon while being in contact with the inner surface of the cylinder 12, and one reinforcement member 20-1 located at the center of the cylinder 12.

On the other hand, a total of four reinforcement members 20-2 configure the second layer. The second layer includes four reinforcement members 20-2 located such that points of the reinforcement members 20-2 coincide with the apexes of a substantially regular quadrangle in a top view.

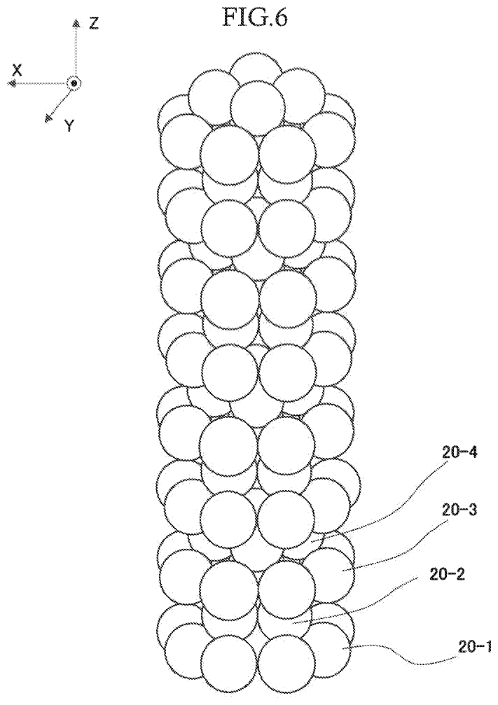

FIG. 6 is a view showing an example of a layer configuration of the reinforcement members 20 in the cylinder 12. As shown in FIG. 6, a third layer formed by a plurality of reinforcement members 20-3 may be arranged in the same manner as the first layer. A fourth layer formed by a plurality of reinforcement members 20-4 has a configuration in which the arrangement in the second layer is rotated by 45 degrees in a plane parallel to the XY plane. The configurations of the first to fourth layers are repeated for the fifth and subsequent layers.

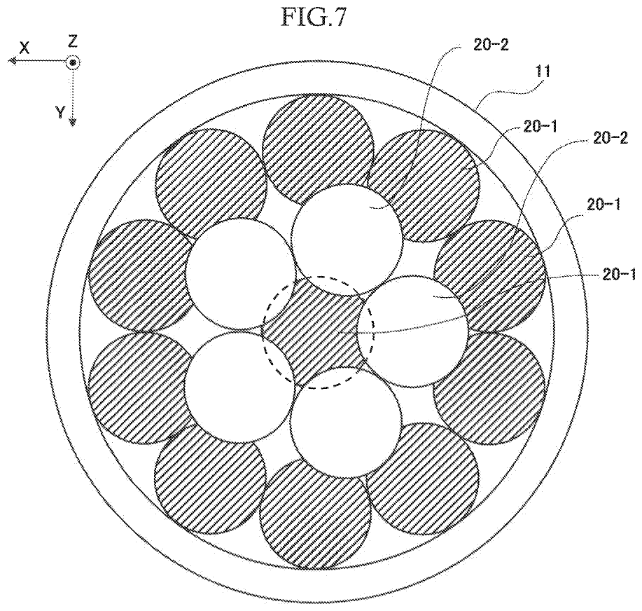

FIG. 7 is a plan view showing an arrangement example of the reinforcement members 20 in the cylinder 11. The plurality of reinforcement members 20 may be arranged in a plurality of layers in the main body portion. In the present example, the plurality of reinforcement members 20 are arranged in the plurality of layers in the axial direction of the cylindrical portion 10. In FIG. 7, the inner diameter of the cylinder 11 is 204.5 mm, and the diameter of each reinforcement member 20 is 48 mm. In FIG. 7, the plurality of reinforcement members 20-1 configure the first layer, and the plurality of reinforcement members 20-2 configure the second layer. In the example of FIG. 7, a total of 11 reinforcement members 20-1 configure the first layer. Specifically, in a top view, the first layer includes ten reinforcement members 20-1 located so that points of the respective reinforcement members 20-1 coincide with the apexes of a substantially regular decagon while being in contact with the inner surface of the cylinder 11, and one reinforcement member 20-1 located at the center of the cylinder 11.

On the other hand, a total of five reinforcement members 20-2 configure the second layer. The second layer includes five reinforcement members 20-2 located such that points of the reinforcement members 20-2 coincide with the apexes of a substantially regular pentagon in a top view. Thus, in each layer, in a top view, it may have a configuration in which the reinforcement members 20 are arranged at the apexes of substantially regular decagon while being in contact with the inner surface of the cylinder 11. Note that the third layer and the fourth layer and thereafter may be similar to the first layer and the second layer.

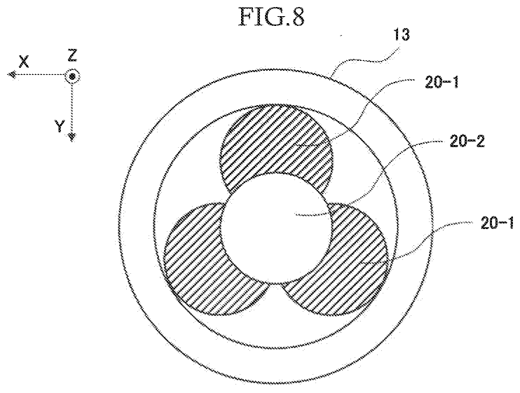

FIG. 8 is a plan view showing an arrangement example of the reinforcement members 20 in the cylinder 13. In FIG. 8, the inner diameter of the cylinder 13 is 106 mm, and the diameter of each reinforcement member 20 is 48 mm. In the cylinder 13, in a top view, the first layer includes three reinforcement members 20-1 located so that points of the respective reinforcement members 20-1 coincide with the apexes of a substantially regular triangle while being in contact with the inner surface of the cylinder 13. The second layer includes one reinforcement member 20-2 located at the center of on the cylinder 13 in top view.

In the arrangement of the reinforcement members 20 in the cylinder 12 shown in FIGS. 5 and 6, the diameter (48 mm) of each reinforcement member 20 is 33% of the inner diameter (180 mm) of the cylinder 12, and is included in the range of 20% or more and 40% or less. In the arrangement of the reinforcement members 20 in the cylinder 11 shown in FIG. 7, the diameter of each reinforcement member 20 (48 mm) is 23% of the inner diameter (204.5 mm) of the cylinder 12, and is included in the range of 20% or more and 30% or less. In the arrangement of the reinforcement members 20 in the cylinder 13 shown in FIG. 8, the diameter (48 mm) of each reinforcement member 20 is 45% of the inner diameter (106 mm) of the cylinder 13, and is included in the range of 20% or more and 50% or less.

In other words, the inner diameter (180 mm) of the cylinder 12 is 3.75 times the diameter of the reinforcement member 20, the inner diameter (204.5 mm) of the cylinder 11 is 4.26 times the diameter of the reinforcement member 20, and the inner diameter (106 mm) of the cylinder 13 is 2.2 times the diameter of the reinforcement member 20. The inner diameter of the cylindrical portion 10 is preferably not less than 1 time and not more than 20 times the diameter of the reinforcement member 20, and more preferably not less than 1 time and not more than 10 times the diameter of the reinforcement member 20, or not less than 2 times and not more than 10 times the diameter of the reinforcement member 20. Thus, it is possible to effectively increase the rigidity of the antenna support pole 1.

However, the arrangement of the reinforcement members 20 in the cylindrical portion 10 is not limited to the cases of FIGS. 5, 6, 7, and 8. In the cylindrical portion 10, the reinforcement members 20 are not necessarily arranged in layers. In particular, when manufacturing the rigidity-enhanced antenna support pole 1 using the existing cylindrical portion 10, the plurality of reinforcement members 20 are carried into the internal space from an opening formed in the main body portion of the cylindrical portion 10, and the plurality of reinforcement members 20 are not necessarily arranged in layers. Even in the case in which the plurality of reinforcement members 20 are randomly arranged without being arranged in layers, the inner diameter of the cylindrical portion 10 is preferably not less than 1 time and not more than 20 times the diameter of the reinforcement member 20, and more preferably not less than 1 time and not more than 10 times the diameter of the reinforcement member 20. The diameter of the reinforcement member 20 is preferably 10 mm or more. The rigidity of the structure can be highest with the reinforcement members 20 each having the diameter of 60 mm among diameters of 10 mm, 20 mm, 40 mm, and 60 mm placed in the cylinder having the inner diameter of 300 mm. When the size of the reinforcement members 20 increases, it is possible to prevent the reinforcement members 20 from moving to a space generated when the structure such as the cylinder is bent by receiving external force, so that the rigidity thereof can be increased.

As shown in FIGS. 1 to 8, according to the antenna support pole 1 of the present embodiment, the reinforcement members 20 are arranged in the cylindrical portion 10. The rigidity in the cylindrical portion 10 can be increased by the reinforcement members 20, and displacement thereof can be suppressed. Therefore, it is possible to suppress the stress generated in the antenna support pole 1. In particular, by setting the inner diameter of the cylindrical portion 10 to be not less than 2 times and not more than 20 times, particularly not less than 2 times and not more than 10 times the diameter of the reinforcement members 20, it is possible to suppress the stress generated in the antenna support pole 1. In particular, according to the results of the simulation and the actual experimental test, it is possible to increase the rigidity in the cylindrical portion 10 by using the reinforcement members 20 in which the base materials 23 are formed of fiber reinforced resin. Depending on the rigidity of the cylindrical portion 10, the reinforcement members 20 including the base materials 22 formed of foamed synthetic resin can be used, and the weight of the antenna support pole 1 can be reduced.

Further, according to the antenna support pole 1 of the present embodiment, the external reinforcement portions 52, 54 are arranged on the outer surface of the cylindrical portion 10 so as to cover a pair of the connected flange portions 14 and ribs 15. As a result, it is possible to cover from the outside a section where local stress is likely to be generated, so that the stress to be generated can be reduced.

Further, the antenna support pole 1 of the present embodiment may include the filler materials arranged at a plurality of positions spaced apart from each other in the axial direction of the cylindrical portion 10. The filler materials having higher curing speed can be used as compared with the case in which the filler materials are filled in the entire inner region of the cylindrical portion 10.

Since the structure of the present example includes the cylindrical portion 10 as the hollow configuration, the structure exhibits flexibility compared with a solid structure having the same sectional area, and generates several times the strength. Further, in the present embodiment, since the filler materials 32 formed of strong polyurea resin are arranged at the plurality of positions spaced apart from each other in the axial direction of the cylindrical portion 10, the filler materials 32 serve as lateral members and the strength as a whole against bending stress can be increased. The above exhibits similar effects as a bamboo nodal structure of a plant.

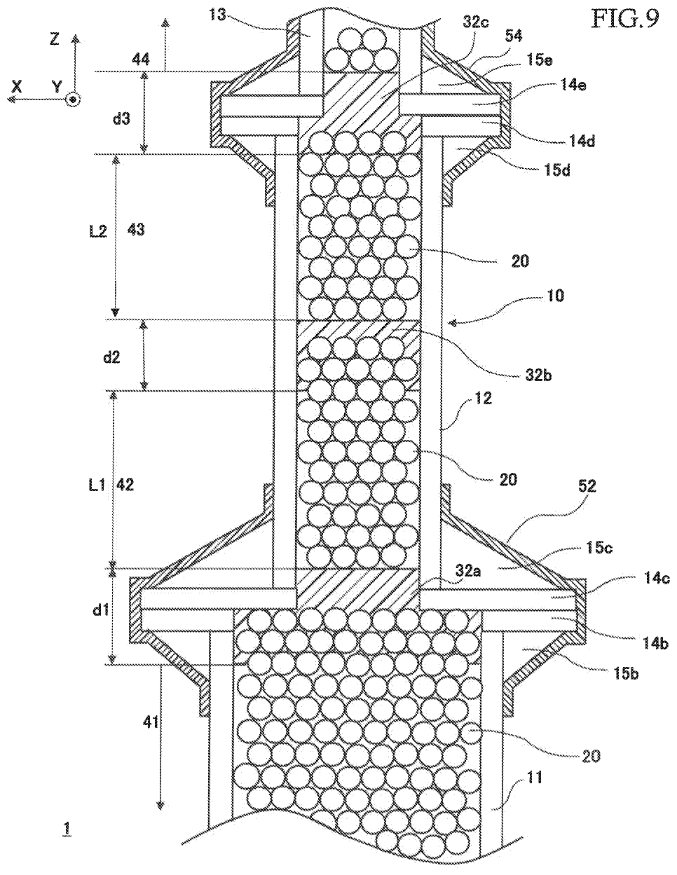

FIG. 9 is a partial sectional view showing an example of the antenna support pole 1 of a second embodiment of the present invention. In the first embodiment, description has been provided on the case in which one filler material 32 is arranged as the fixing portion 30 in one cylinder, but the present invention is not limited thereto. As shown in FIG. 9, a plurality of filler materials 32b, 32c may be arranged in one cylinder 12. In the present example, three or more filler materials 32a, 32b, 32c are arranged in the entire cylindrical portion 10.

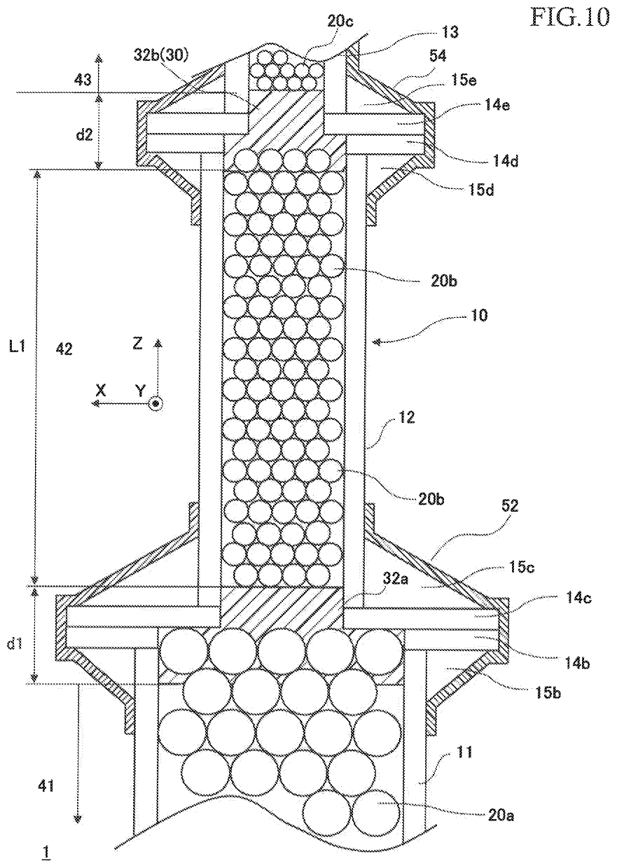

FIG. 10 is a partial sectional view showing an example of the antenna support pole 1 of a third embodiment of the present invention. The plurality of reinforcement members 20 may include reinforcement members 20a, 20b, 20c having different sizes. In this example, the diameters of the reinforcement members 20a, 20b, 20c increase as the inner diameters of the cylinders 11, 12, 13 increase. In particular, the sizes of the plurality of arranged reinforcement members 20a, 20b, 20c t may be different from each other in correspondence to regions separated by the fixing portion 30 (in the present example, the filler materials 32a, 32b). In the present example, the sizes of the plurality of reinforcement members 20a, 20b, 20c arranged in a region 41, a region 42, and a region 43 are different from each other. By setting positions of the filler material 32a and the filler material 32b in accordance with the inner diameters and shapes of the cylinders, the sizes of the reinforcement members 20a, 20b, 20c can be changed in accordance with the inner diameter of the cylinder. Therefore, it is easy to densely arrange the reinforcement members 20a, 20b, 20c in the cylinder. As a result, it is possible to increase the strength of the antenna support pole 1. Further, the elasticity (rigidity) of each coating layer 24 of the plurality of arranged reinforcement members 20a, 20b, 20c may be different in correspondence to the region separated by the filler material 32a and the filler material 32b. In one example, the reinforcement member 20a may be more rigid (less elastic) than the reinforcement member 20b and the reinforcement member 20b may be more rigid (less elastic) than the reinforcement member 20c, or vice versa.

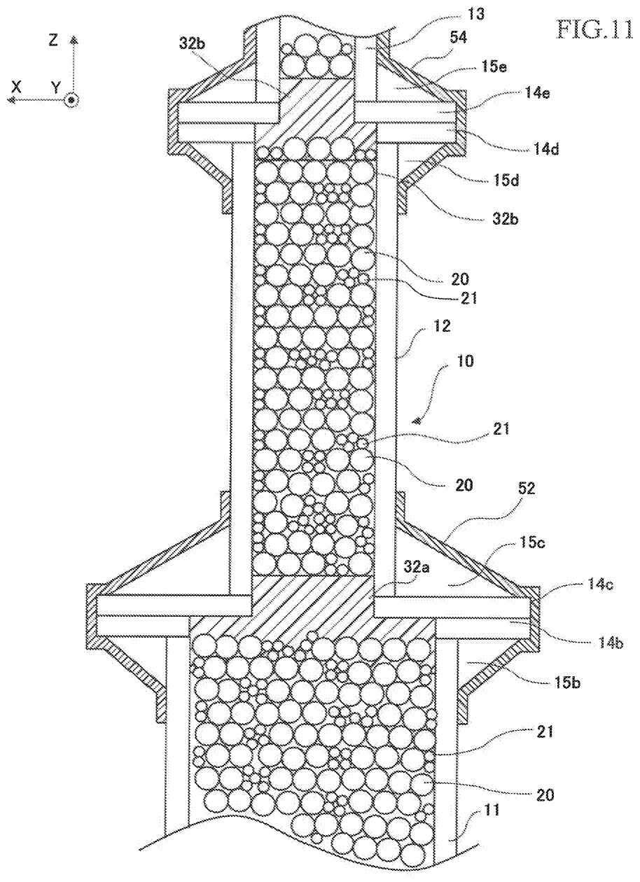

FIG. 11 is a partial sectional view showing an example of the antenna support pole 1 in a fourth embodiment of the present invention. The plurality of reinforcement members 20 may include reinforcement members 20, 21 having different sizes. The reinforcement members 20 and the reinforcement members 21 may be mixed in a region in the cylindrical portion 10. As shown in FIG. 11, the reinforcement members 20, 21 are not necessarily arranged in layers, but may be arranged randomly.

As shown in FIG. 11, the reinforcement members 20 and the reinforcement members 21 having diameters different from each other are mixed in the cylindrical portion 10, so that the filling rate of the reinforcement members 20, 21 in the cylindrical portion 10 can be increased. Therefore, it is easy to densely arrange the reinforcement members 20, 21 in the cylinder. As a result, it is possible to increase the strength of the antenna support pole 1.

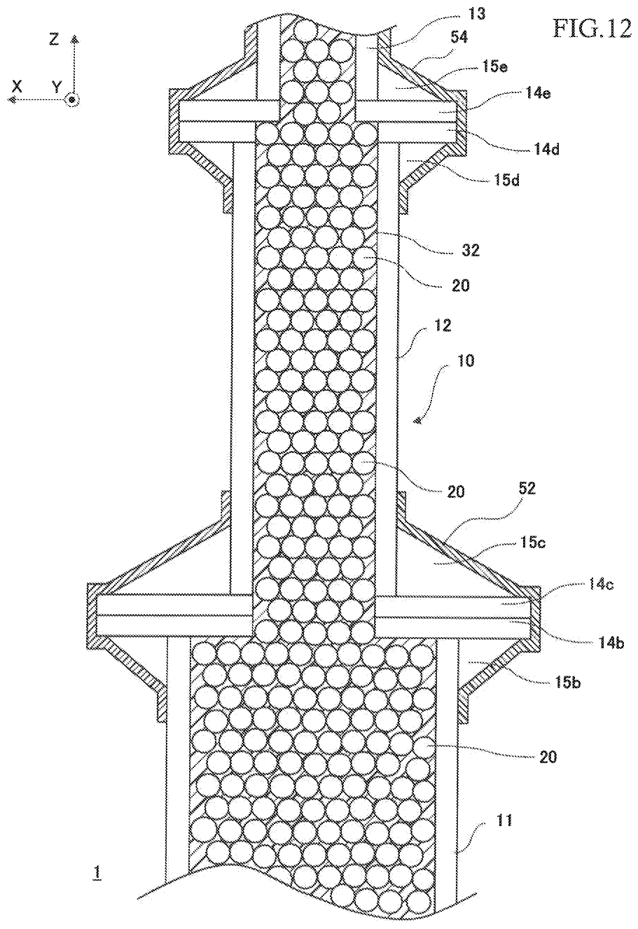

FIG. 12 is a partial sectional view showing an example of the column body for antenna support in a fifth embodiment of the present invention. As shown in FIG. 12, the filler materials 32 filled over the entire inside of the cylindrical portion 10 may be used as the fixing portion 30. In this case, the filler materials 32 having lower curing speed than polyurea resin may be used.

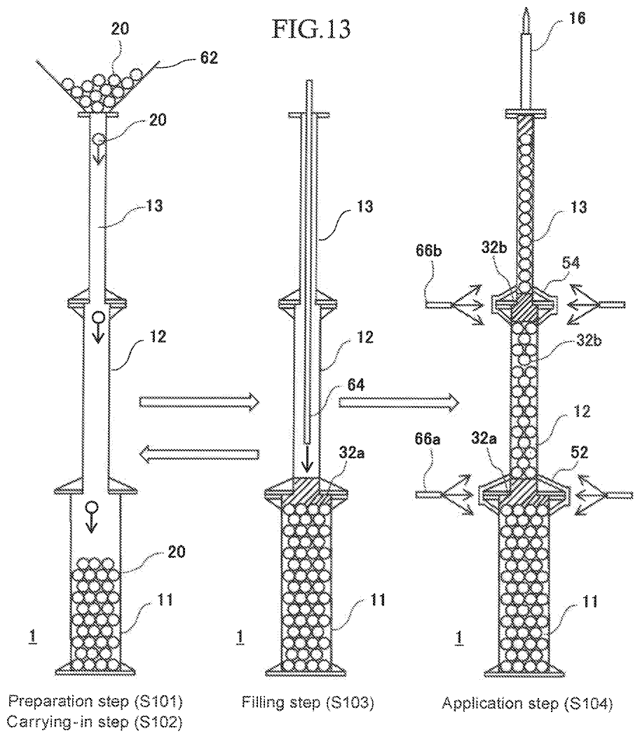

FIG. 13 is a view showing an example of a manufacturing method of the structure of the present invention. In the present example, a manufacturing method of an antenna support pole is shown as an example of the structure. In the present example, the structure includes the main body portion having the hollow configuration surrounding the internal space. The manufacturing method of the structure includes a preparation step (step S101). In the preparation step (step S101), the plurality of reinforcement members 20 are prepared. As shown in FIG. 4A, the reinforcement member 20 may include the base material 22 formed of foamed synthetic resin and the coating layer 24 which is formed of polyurea resin and which covers the outer surface of the base material 22. However, the reinforcement member 20 may include the base material 23 formed of fiber reinforced resin and the coating layer 24 which is formed of polyurea resin and which covers the outer surface of the base material 23 as shown in FIG. 4D, and may include the base material 23 formed of fiber reinforced resin without including the coating layer 24 as shown in FIG. 4E.

The manufacturing method includes a carrying-in step in which a plurality of reinforcement members 20 are carried into the internal space through an opening formed in the main body portion (step S102). For example, taking the cylindrical portion 10 shown in FIG. 1 as an example, first, the portion of the lightning rod 16 is detached, and one end (upper end) of the cylindrical portion 10 with which the cylinder 13, the cylinder 12, and the cylinder 11 communicate is exposed. That is, in the cylindrical portion 10 shown in FIG. 1, the opening is arranged at one end of the cylindrical portion 10, and the portion of the lightning rod 16 functions as a cover portion for closing the opening. Then, using a supply unit 62 for the reinforcement members 20, a plurality of the reinforcement members 20 is carried into the cylindrical portion 10 from the one end of the cylindrical portion 10. The carried-in reinforcement members 20 are sequentially arranged from the bottom of the cylindrical portion 10.

The manufacturing method includes a step of arranging the fixing portion 30 for fixing the plurality of reinforcement members 20 into the main body portion. In the present example, the step of arranging the fixing portion 30 includes a filling step of filling, to at least a part of the inside of the cylindrical portion 10, the filler material 32 for fixing the plurality of reinforcement members 20 into the cylindrical portion 10 (step S103). In the filling step S103, the filler material 32 is filled so as to be in contact with at least some reinforcement members 20 among the plurality of reinforcement members 20 and the inner surface of the cylindrical portion 10. The filler material 32 may be formed of polyurea resin.

In one example, when a predetermined amount of the reinforcement members 20 is carried into the cylindrical portion 10, the carrying-in of the reinforcement members 20 is stopped. Then, the filler material 32a is filled through a nozzle 64 or the like inserted into the cylindrical portion 10. Since the reinforcement members 20 are arranged in the cylindrical portion 10, the process can be completed in a short period of time as compared with the case in which the space in the cylindrical portion 10 is filled with only the filler material 32a. Further, unlike the case in which the space in the cylindrical portion 10 is filled with only the filler material 32a, polyurea resin having relatively low curing speed can be used as the filler material 32a, and the rigidity of the antenna support pole 1 can be increased.

The carrying-in step (step S102) and the filling step (step S103) are repeatedly performed a plurality of times. In other words, the carrying-in step (step S102) is performed before and after the step of arranging the fixing portion 30, respectively. In the present example, the carrying-in step (step S102) is performed before and after the filling step (step S103), respectively. As a result, the internal space of the main body portion is separated into a plurality of regions. In the present example, the filler materials 32a, 32b are arranged at a plurality of positions spaced apart from each other in the axial direction of the cylindrical portion 10. Note that an insertion device inserted into the cylindrical portion 10 may alternately supply the reinforcement members 20 and the filler material 32 at predetermined time intervals. The sizes of the plurality of arranged reinforcement members 20 may be different from each other in correspondence to the separated regions. Further, the elasticity of the coating layer 24 of the plurality of arranged reinforcement members 20 may be different in correspondence to the separated regions.

In the carrying-in step S102, as shown in FIGS. 10 and 11, the reinforcement members 20 having different sizes may be carried into the cylindrical portion 10. Further, in the carrying-in step S102, the plurality of reinforcement members 20 may be arranged in a plurality of layers in the main body portion, or may be arbitrarily filled and arranged without forming layers. For example, the plurality of reinforcement members 20 may be arranged in a plurality of layers in the axial direction of the cylindrical portion 10.

Further, the manufacturing method may include an application step (step S104). The cylindrical portion 10 includes the cylinder 11, the cylinder 12, and the cylinder 13. Each cylinder has the flange portion 14 for connection with the adjacent cylinder. The cylindrical portion 10 is configured with the flange portions 14 of the adjacent cylinders connected to each other. Then, in the application step (step S104), polyurea resin is applied to the outer surface of the cylindrical portion 10 so that polyurea resin covers the pair of connected flange portions 14. Thus, the external reinforcement portions 52, 54 containing polyurea resin are formed on the outer surface of the cylindrical portion 10. For example, the external reinforcement portions 52, 54 containing polyurea resin may be formed through a nozzle 66a, a nozzle 66b, or the like arranged toward a side surface of the cylindrical portion 10.

According to the manufacturing method described above, it is possible to manufacture the antenna support pole 1 having enhanced rigidity while using the existing cylindrical portion 10 having been installed in a base station or the like. In other words, the manufacturing method of the present embodiment can also be used as a reinforcing method of the existing antenna support pole 1. Naturally, the manufacturing method of the present embodiment can also be utilized as a manufacturing method of the antenna support pole 1 which is completely new without using the existing cylindrical portion 10.

The manufacturing method is not limited to the case shown in FIG. 13, and various modifications can be adopted.

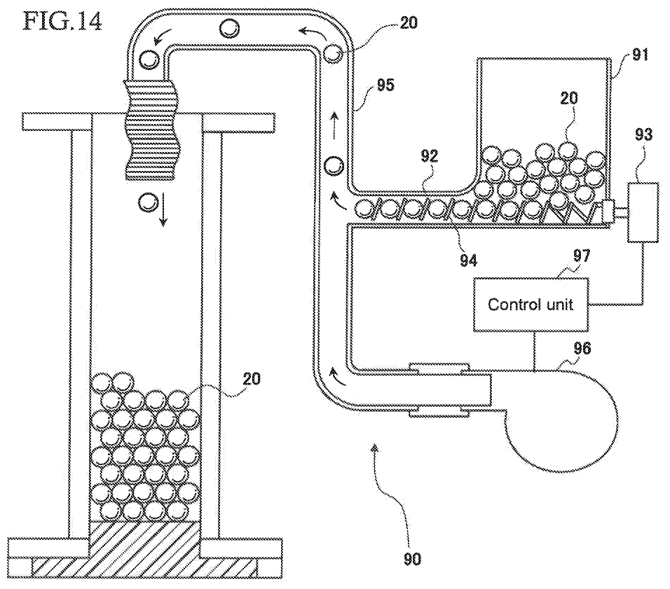

FIG. 14 is a view showing an example of a carrying-in device 90. The carrying-in device 90 includes a storage tank 91, a supply pipe 92, a motor 93, an alignment supply device 94, a conveyance pipe 95, a blower 96, and a control unit 97. The reinforcement members 20 stored in the storage tank 91 is supplied through the supply pipe 92 into the conveyance pipe 95 having an inner diameter slightly larger than the reinforcement members 20 by the alignment supply device 94 driven by the motor 93. Compressed air discharged from the blower 96 flows into the conveyance pipe 95 to convey the reinforcement members 20 in the conveyance pipe 95. The plurality of reinforcement members 20 may be carried into the internal space of the main body portion using the carrying-in device 90 described above. The control unit 97 controls the blower 96 and the motor 93. According to the carrying-in device 90 described above, it is possible to increase the number of the reinforcement members 20 to be carried-in in per unit time. Further, since the reinforcement members 20 are fed into the internal space by applying pressure into the conveyance pipe 95, it is easy to arrange the plurality of reinforcement members 20 at the internal space. In other words, the manufacturing method of the structure of the present invention may further include a pressing step of pressing the plurality of reinforcement members 20 into the internal space, and after the pressing step, the plurality of reinforcement members 20 may be fixed in the main body portion by the fixing portion 30. Here, means for pressing the plurality of reinforcement members 20 into the internal space is not limited to compressed air. The pressing may be performed by a pressing rod or the like. In particular, when the plurality of reinforcement members 20 are arbitrarily filled and arranged without forming layers, the density of the filled reinforcement members 20 is increased and positioning thereof is performed by the pressing. As a result, the effect of increasing the strength of the structure is increased.

In the first to fifth embodiments described above, the filler material 32 is mainly described as the fixing portion 30 for fixing the plurality of reinforcement members 20 into the main body portion. However, the fixing portion 30 is not limited to the filler material 32.

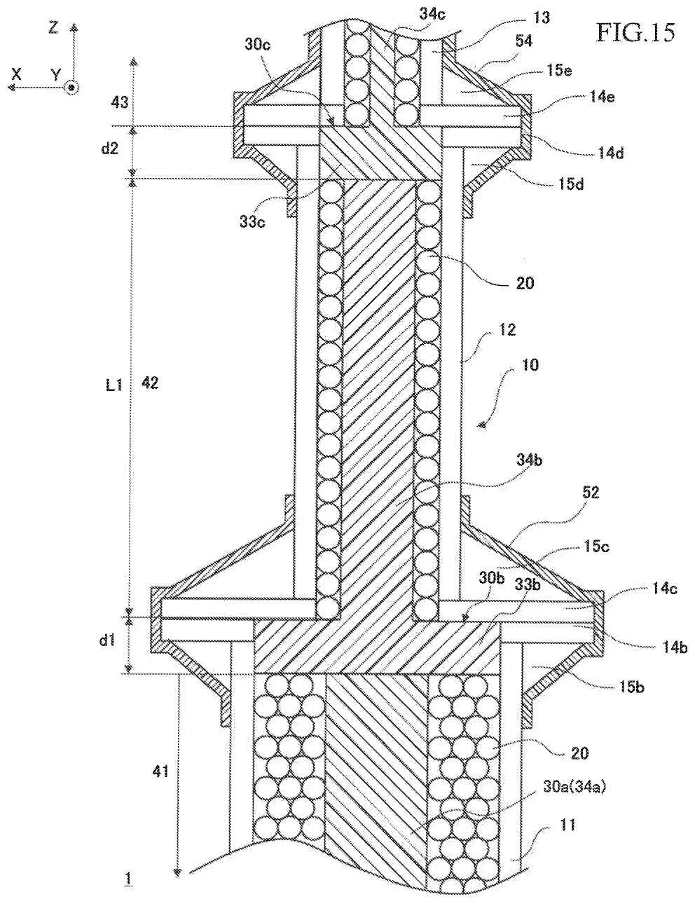

FIG. 15 is a partial sectional view showing an example of the antenna support pole 1 in a sixth embodiment of the present invention. The overall configuration in the sixth embodiment is similar to that in the first embodiment shown in FIGS. 1 to 8. FIG. 15 schematically shows a cross-section of the section A of FIG. 1 taken along the ZX plane.

The main body portion of the antenna support pole 1 includes at least one fixing portion 30 which fixes the plurality of reinforcement members 20 into the main body portion. The fixing portion 30 fixes the plurality of reinforcement members 20 into the cylindrical portion 10. In the present example, the fixing portion 30 includes a connection portion 33 and an extension portion 34. The fixing portion 30 may be formed of metal or resin. For example, glass fiber reinforced resin (GFRP) or carbon fiber reinforced resin (CFRP) is used as the resin. The connection portion 33 and the extension portion 34 may be integrally formed. The side surface of the connection portion 33 is connected to the inner surface of the hollow configuration. The connection portion 33 may have a plate shape. In one example, the connection portion 33 includes two main surfaces and a side surface which connects the two main surfaces. The side surface of the plate-shaped connection portion 33 may be connected to the inner surface of the hollow configuration. In the present example, the connection portion 33 is connected to the inner surface of the cylindrical portion 10. In one example, the connection portion 33 may be connected to the inner surface of the hollow configuration by being press-fitted into the hollow configuration, or may be connected to the inner surface of the hollow configuration by an adhesive, welding, or the like. The shape of the connection portion 33 may correspond to the shape of the internal space of the hollow configuration. In one example, the shape of the connection portion 33 may be a disc shape corresponding to the inner diameter shape of the cylindrical portion 10. The connection portion 33 may separate the internal space into a plurality of regions. In the present example, the inside of the cylindrical portion 10 is separated into a plurality of regions.

The extension portion 34 may extend from the main surface of the connection portion 33 along the extension direction of the hollow configuration. When the hollow configuration is the cylindrical portion 10 as in the present example, the extension portion 34 may extend along the axial direction of the cylindrical portion 10. The extension portion 34 may extend from the vicinity of the center of one main surface of the connection portion 33. The diameter of the extension portion 34 may be 10% or more and 80% or less of the inner diameter of the cylindrical portion 10.

The inside of the cylindrical portion 10 may be separated into the region 41, the region 42, and the region 43 in the axial direction of the cylindrical portion 10. The three cylinders 11, 12, 13 are connected to form the cylindrical portion 10. One fixing portion 30 may be arranged in one cylinder. Taking the region 42 as an example, the extension portion 34b of the fixing portion 30b is arranged in the cylinder 12. An end part of the extension portion 34b is in contact with the main surface (front surface or back surface) of the connection portion 33c of the other adjacent fixing portion 30c in the vicinity of the connection region between the cylinder 12 and the cylinder 13. The plurality of reinforcement members 20 may be arranged in the space between the extension portion 34b and the inner surface of the hollow configuration. In the present example, the plurality of reinforcement members 20 are arranged in the space between the extension portion 34b and the inner surface of the cylindrical portion 10. Then, positions of the plurality of reinforcement members 20 are fixed by the connection portion 33b, the connection portion 33c, the extension portion 34b, and the inner surface of the cylindrical portion 10 (hollow configuration).

According to the structure of the present example, since the extension portion 34 is arranged, the number of the reinforcement members 20 required to be arranged at the internal space can be reduced. In the present example, the rigidity of the cylindrical portion 10 can be increased while reducing the number of the reinforcement members 20 arranged in the cylindrical portion 10.

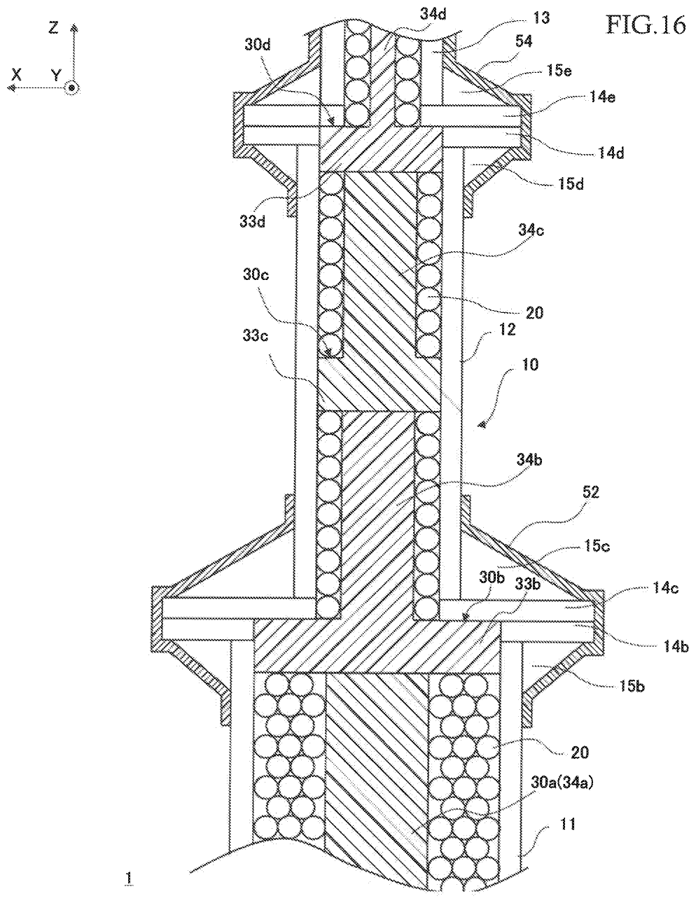

FIG. 16 is a partial sectional view showing an example of the antenna support pole 1 in a seventh embodiment of the present invention. In the sixth embodiment shown in FIG. 15, description has been provided on the case in which one fixing portion 30 is arranged in one cylinder, but the present invention is not limited thereto. As shown in FIG. 16, a plurality of fixing portions 30b, 30c may be arranged in one cylinder 12. The fixing portion 30b is arranged at a position closer to the vicinity of the connection region between the cylinder 12 and the cylinder 11 than the fixing portion 30c. In contrast, the fixing portion 30c is arranged at a position closer to the vicinity of the connection region between the cylinder 12 and the cylinder 13 than the fixing portion 30b.

The fixing portion 30b includes a connection portion 33b arranged in the vicinity of the connection region between the cylinder 12 and the cylinder 11, and an extension portion 34b extending from the connection portion 33b. The fixing portion 30c includes a connection portion 33c arranged in the vicinity of the center portion in the longitudinal direction of the cylinder 12, and an extension portion 34c extending from the connection portion 33c. According to the present embodiment as well, the rigidity of the cylindrical portion 10 can be increased while reducing the number of the reinforcement members 20 arranged in the cylindrical portion 10.

In the example shown in FIGS. 15 and 16, the fixing portion 30 includes the connection portion 33 and the extension portion 34, but the fixing portion 30 may include the connection portion 33 without including the extension portion 34. In this case, the connection portions 33 may be metal plates which cover ends of the cylinders 11, 12, 13.

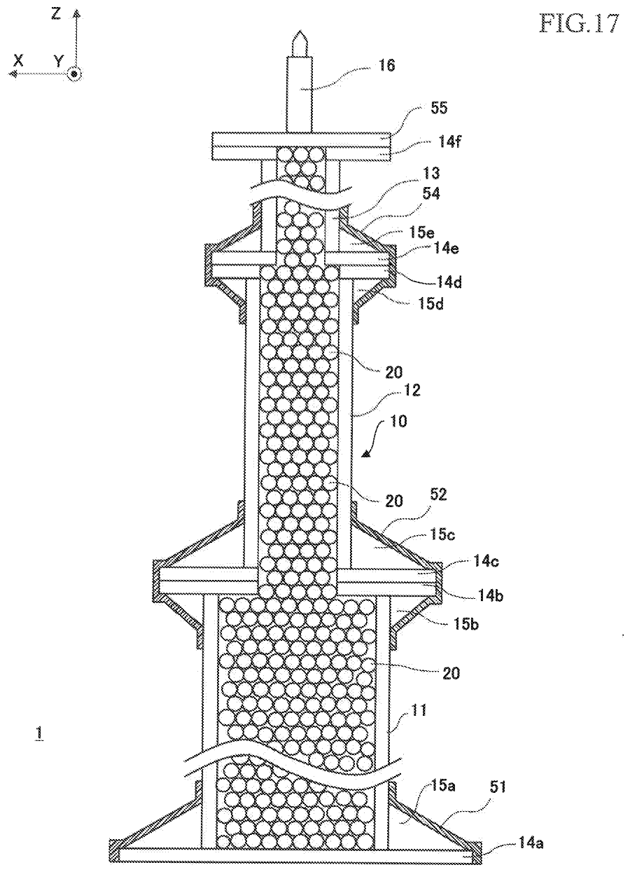

FIG. 17 is a sectional view showing an example of the antenna support pole 1 in an eighth embodiment of the present invention. In FIG. 17, an opening is arranged at a part of the cylindrical portion 10. In the present example, the opening is arranged at the top end of the cylindrical portion 10. Then, the main body portion of the cylindrical portion 10 includes a cover portion 55 which closes the opening. In the present example, the cover portion 55 is connected to a flange portion 14f. By closing the opening with the cover portion 55, the plurality of reinforcement members 20 are fixed into the main body portion. Thus, in the present example, the cover portion 55 functions as the fixing portion 30. The cover portion 55 is, for example, a metal plate. The lightning rod 16 or the like may be attached to the cover portion 55. In the present example, the filler material 32 may not be arranged as the fixing portion 30. In the present example as well, the configurations of the external reinforcement portions 51, 52, 54 and the like are similar to those of the first embodiment shown in FIG. 3.

According to the present example, since the cover portion 55 functions as the fixing portion 30, construction is facilitated when manufacturing the antenna support pole 1 or the like using the existing pipe.

In the first to eighth embodiments, description has been provided mainly on the case in which the reinforcement member 20 has a spherical shape. However, the shape of the reinforcement member 20 is not limited to the spherical shape.

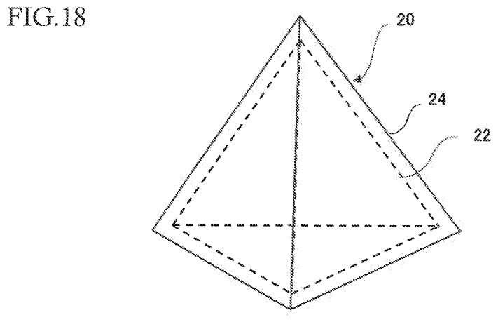

FIG. 18 is a view showing another example of the reinforcement member 20. As shown in FIG. 18, the reinforcement member 20 may have a polyhedral shape. In the example shown in FIG. 18, the reinforcement member 20 has a regular tetrahedron shape, but the shape of the reinforcement member 20 is not limited to the regular tetrahedron shape. The reinforcement member 20 shown in FIG. 18 may also include the base material 22 and the coating layer 24 which covers the outer surface of the base material 22. The base material 22 may have a polyhedron shape corresponding to the shape of the reinforcement member 20.

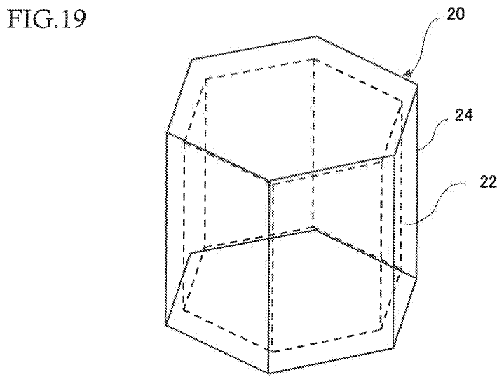

FIG. 19 is a view showing another example of the reinforcement member 20. As shown in FIG. 19, the reinforcement member 20 may have a columnar shape. In the example shown in FIG. 19, the reinforcement member 20 has a regular hexagonal prism shape. The regular hexagonal prism having a regular hexagonal bottom surface can be most densely arranged in the plane. However, not limited to the regular hexagonal prism shape, the reinforcement member 20 may be another polygonal prism or it may be a column. The reinforcement member 20 shown in FIG. 18 may also include the base material 22 and the coating layer 24 which covers the outer surface of the base material 22. The base material 22 may have a columnar shape corresponding to the shape of the reinforcement member 20.

Owing to that the reinforcement members 20 each having a shape other than a spherical shape, as shown in FIG. 18 or FIG. 19, are arranged in the hollow configuration, a virtual frame structure is formed in the hollow configuration due to the coating layers 24 each covering the outer surfaces of the reinforcement members 20. Therefore, according to the reinforcement members 20, the strength of the hollow configuration can be increased from the inside. In the case in which the reinforcement member 20 has a columnar shape or a polyhedral shape, the maximum size of the shape may be one time or more and 20 times or less, or one time or more and 10 times or less of the maximum size of the cross-section of the hollow configuration taken perpendicularly to the axial direction. When the reinforcement member 20 has a columnar shape or a polyhedral shape, the maximum size of the shape may be 10 mm or more.

Also in the reinforcement member 20 shown in FIGS. 18 and 19, as described with reference to FIGS. 4D and 4E, the base material 23 formed of fiber reinforced resin (FRP) may be employed instead of the base material 22 formed of foamed synthetic resin. In the case in which the reinforcement member 20 includes the base material 23 formed of fiber reinforced plastic (FRP), the coating layer 24 which covers the outer surface of the base material 23 may be omitted.

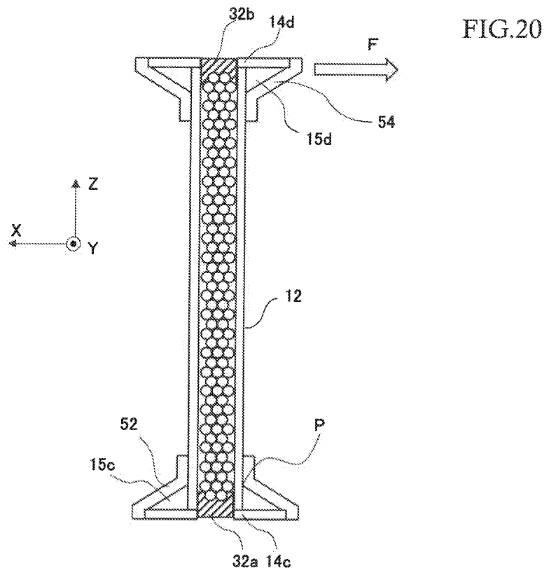

FIG. 20 is a view for explaining conditions of a simulation test. As the cylinder 12, a cylinder having an outer diameter of 190.7 mm, an inner diameter of 180.1 mm, and a length of 2.3 m was used. The reinforcement member 20 of a plurality of spherical shapes were arranged inside the cylinder 12, so as to form a layer configuration shown in FIGS. 5 and 6. In the vicinity of one end and the other end of the cylinder 12, the filler material 32a and the filler material 32b were arranged as the fixing portions 30, and positions of the spherical reinforcement members 20 were fixed. The thickness of the filler material 32a and the filler material 32b in the axial direction (Z-axis direction) was about 30 mm.

The spherical reinforcement member 20 having a diameter of 48 mm was used. Specifically, the reinforcement member 20 which includes the base material 22 having a diameter of 40 mm and the coating layer 24 formed of polyurea resin having a film thickness of 4 mm was used. The external reinforcement portion 52 which covers the flange portion 14c and the ribs 15c at one end of the cylinder 12 was arranged. The external reinforcement portion 52 has a film thickness of 4 mm, and a part thereof extends along the side surface of the cylinder 12. Similarly, the external reinforcement portion 54 which covers the flange portion 14d and the ribs 15d at the other end of the cylinder 12 was arranged. The external reinforcement portion 54 has a film thickness of 4 mm, and a part thereof extends along the side surface of the cylinder 12.

On the other hand, as a comparative example, a simulation test was also performed on a support pole having a similar configuration except that the reinforcement members 20, the filler materials 32a, 32b, the external reinforcement portion 52, and the external reinforcement portion 54 were not arranged.

In the simulation test, a force of 10000 (N) was applied in the X-axis direction from the side surface at the upper end (top end) of the cylinder 12. As a result, it was found that the maximum stress was applied to the rib 15c arranged at the lower end (base end) of the cylinder 12, as shown by the point P in FIG. 20, in both the present example and the comparative example. In the present example, the maximum stress at the rib 15c was 156.1 (N/mm²). On the other hand, in the comparative example, the maximum stress at the ribs 15c was 249.7 (N/mm²). From the results described above, it was found that the stress concentration on the ribs 15c was alleviated by arranging the reinforcement members 20, the filler material 32a, the filler material 32b, the external reinforcement portion 52, and the external reinforcement portion 54 as in the present example. Similar effects were obtained as well in the cylinder 11 and the cylinder 13.

In the following, the simulation results are verified. The height h of the antenna support pole 1 is 2.3 m, the outer diameter D₁ thereof is 190.7 mm, and the inner diameter D₂ thereof is 180.1 mm. When a force of F (N) is applied in the X-axis direction from the side surface at the upper end of the antenna support pole 1, the action moment M applied to the bottom surface of the antenna support pole 1 is obtained as M=F·h=23000 (N·m). The stress σ at the bottom surface is given by σ=M/Z. Here, Z is a sectional coefficient and given by Z=I(moment of inertia)/e(distance of the center of gravity). Assuming that I=(π(D₁⁴−D₂⁴)/64)/(D₁/2)=1328 (cm⁴) and e=14.4 (mm), Z=1328/14.4=92.2 (cm³) is obtained. From the above, the stress is obtained as σ=M/Z=23000/92.2=250 (N/mm²). Next, assuming that the inner diameter is equivalently decreased by arranging the reinforcement members 20, the filler material 32a, the filler material 32b, the external reinforcement portion 52, and the external reinforcement portion 54, and D₂=172.7 (mm), similar calculation provides the followings:
I=2125.4 (cm⁴);
e=14.4 (mm);
Z=147.6; and
σ=M/Z=23000/147.6=156 (N/mm²).

The above agrees with the measurement results. That is, the thickness of the member of the antenna support pole 1, which is 5.3 mm (=(190.7−180.1)/2) without implementing the present invention, is equivalent to 9 mm (=(190.7−172.7)/2), which is equivalently increased by 3.7 mm.

Since the reinforcement members 20 coated with polyurea resin are arranged in the cylindrical portion 10, the rigidity of the cylindrical portion 10 can be increased, and the displacement of the cylindrical portion 10 can be suppressed, so that the stress generated at the point P is suppressed. Further, by arranging the external reinforcement portions 52, 54, a portion where stress is likely to increase is coated from the outside, and thus stress to be generated is suppressed.

Further, a three-point bending test was performed using a cylinder having an outer diameter of 190.7 mm, an inner diameter of 180.1 mm, a thickness of 5.3 mm, and a length of 800 mm. Two receiving round rods were separated by a center-to-center distance of 600 mm, and a sample was placed thereon. Then, the middle point of the center-to-center distance 600 mm of the two receiving round rods were pushed by a pushing round rod, and breaking load was measured. The receiving round rods and the pushing round rod were 50 mm in diameter. As a result, by arranging, at the internal space of the cylinder, the reinforcement members 20 of a diameter of 40 mm, including the base material 22 formed of foamed synthetic resin and the coating layer 24 which covers the outer surface of the base material 22, the breaking load (N) was increased by about 15% compared with the case in which the reinforcement members 20 were not arranged. In the case in which the reinforcement members 20 were arranged in the internal space of the cylinder through the pressing step of pressing the plurality of reinforcement members 20 at the internal space, the breaking load (N) was higher by about 20% compared with the case in which the reinforcement members 20 were not arranged.

Further, in the simulations, when the reinforcement members 20 each having a diameter of 40 mm or 20 mm including the base material 23 of glass fiber reinforced resin (GFRP) or carbon fiber reinforced resin (CFRP) were arranged in the internal space of the cylinder (see FIG. 4D and FIG. 4E), although affected by the rigidity of the cylinder itself, the displacement amount was reduced by 23.8% as compared with the case in which the reinforcement members 20 each having a diameter of 40 mm including the base material 22 formed of foamed synthetic resin and the coating layer 24 which covers the outer surface of the base material 22 were arranged at the internal space of the cylinder.

Further, in the simulations, when the reinforcement members 20 formed of glass fiber reinforced resin (GFRP) or carbon fiber reinforced resin (CFRP) were arranged and fixed in the cylinder and the external reinforcement portion 52 was arranged, the rigidity was improved by 17.8% compared with the case in which the reinforcement members 20 and the external reinforcement portion 52 were not arranged. At this time, the stress applied to the base end was reduced by about 65%. Further, the effects of rigidity improvement and stress reduction were confirmed to the same extent in an actual antenna support pole in which the cylindrical portion 10 is configured by connecting the three cylinders 11, 12, 13.

Although description has been provided on the antenna support pole 1, the configuration of the cylindrical portion 10 is not limited to the example shown in FIG. 1. In the above description of the first to eighth embodiments, the reinforcement members 20 or the filler materials 32a, 32b are arranged at the internal space of the cylindrical portion 10 in the region from the base end to the top end of the cylindrical portion 10. Specifically, description has been provided on the case in which the reinforcement members 20 are arranged at the internal space of the cylindrical portion 10 in the region from the base end to the top end of the cylindrical portion 10 except for the region filled with the filler materials 32a, 32b. However, the present invention is not limited thereto.

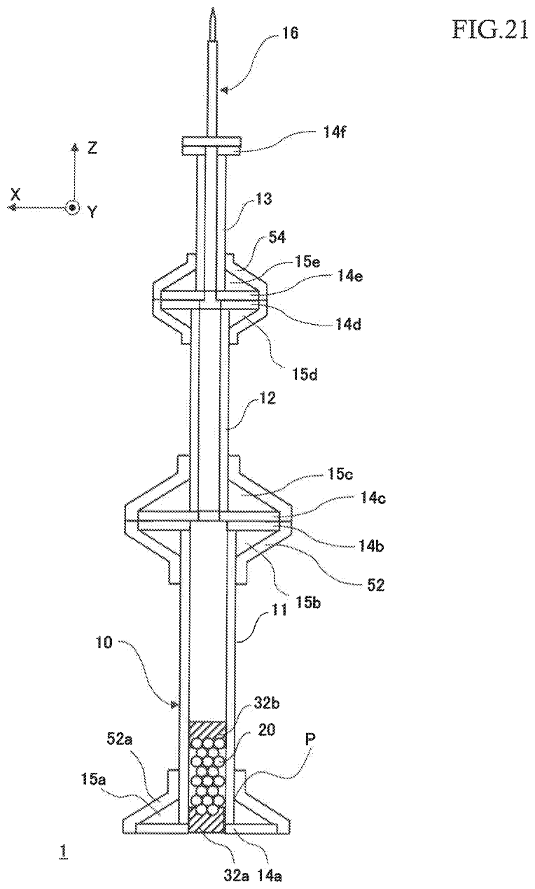

FIG. 21 is a view showing a modification example of the antenna support pole 1. As shown in FIG. 21, in the axial direction of the cylindrical portion 10 (Z-axis direction), a plurality of reinforcement members 20 are arranged in a partial region at the base end (−Z side end). Except for the partial region at the base end, the reinforcement members 20 are not arranged at the internal space of the cylindrical portion 10. According to the simulation results under the conditions shown in FIG. 20, the maximum stress is applied to the ribs 15a arranged at the base end of the cylindrical portion 10 (the lower end). Therefore, the partial region at the base end is arranged so as to correspond to the portion where the maximum stress is applied in the axial direction of the cylindrical portion 10 (Z-axis direction). Assuming that the length of the cylindrical portion 10 is L, the partial region at the base end may be in the range of L/3 or in the range of L/5 from the end of the base end of the cylindrical portion 10.

In the modification example shown in FIG. 21, the cylindrical portion 10 includes the plurality of cylinders 11, 12, 13. Among the plurality of cylinders 11, 12, 13, the cylinder 11 is arranged at a position closest to the base end of the cylindrical portion 10, the cylinder 13 is arranged at a position closest to the top end of the cylindrical portion 10, and the cylinder 12 is arranged between the cylinder 11 and the cylinder 13. In the present modification example, the reinforcement members 20 are arranged at the internal space of the cylinder 11 arranged at the position closest to the base end of the cylindrical portion 10 among the plurality of cylinders 11, 12, 13.

The present modification example includes at least one fixing portion 30 which fixes the plurality of reinforcement members 20 into the cylindrical portion 10 in a partial region at the base end. In the present modification example, the fixing portion 30 includes the filler materials 32a, 32b. The filler materials 32a, 32b are filled in at least a part of the inside of the hollow configuration so as to be in contact with at least some reinforcement members 20 among the plurality of reinforcement members 20 and an inner surface of the hollow configuration.

In the present modification example, the plurality of filler materials 32a, 32b are formed as the filler material 32. The filler material 32a is arranged at a position closer to the base end than the filler material 32b. The positions of the plurality of reinforcement members 20 may be fixed by sandwiching the plurality of reinforcement members 20 between the filler material 32a and the filler material 32b in the axial direction of the cylindrical portion 10.

According to the present modification example, in the region at the base end, the plurality of reinforcement members 20 are arranged at the internal space of the cylindrical portion 10. Therefore, it is possible to effectively increase the rigidity of the cylindrical portion 10. Further, since the plurality of reinforcement members 20 are arranged in a concentrated manner in the partial region at the base end, it is possible to reduce the use amount of the plurality of reinforcement members 20, and shorten the carrying-in step of carrying the plurality of reinforcement members 20 into the cylindrical portion 10.

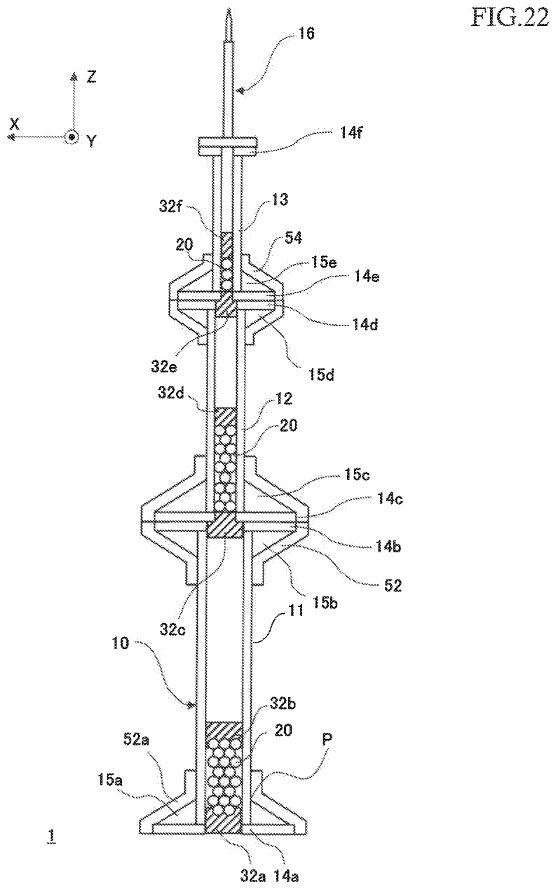

FIG. 22 is a view showing a modification example of the column body for antenna support. The cylindrical portion 10 includes the plurality of cylinders 11, 12, 13. In the axial direction of the cylindrical portion 10 (Z-axis direction), the plurality of reinforcement members 20 are arranged in a partial region at the base end of each of the cylinders 11, 12, 13. In the axial direction of the cylindrical portion 10 (Z-axis direction), the plurality of reinforcement members 20 are arranged in the partial region at the base end (−Z side end) of the cylinder 11. Except for the partial region at the base end, the reinforcement members 20 are not arranged at the internal space of the cylinder 11. Similarly, the plurality of reinforcement members 20 are arranged in the partial region at the base end (−Z side end) of the cylinder 12. The plurality of reinforcement members 20 are arranged in the partial region at the base end of the cylinder 13. Assuming that the length of the cylinder 11 is L, the partial region at the base end may be in the range of L/3 or in the range of L/5 from the end of the base end of the cylinder 11. The partial regions at the base ends of the cylinder 12 and the cylinder 13 may be the same as in the case of the cylinder 11.

The present modification example includes at least one fixing portion 30 which fixes the plurality of reinforcement members 20 into the cylinder 11 in the partial region at the base end of the cylinder 11. In the present modification example, the fixing portion 30 includes the filler materials 32a, 32b. The filler materials 32a, 32b are filled in at least a part of the inside of the hollow configuration so as to be in contact with at least some reinforcement members 20 among the plurality of reinforcement members 20 and an internal surface of the hollow configuration.

In the present modification example, in the cylinder 11, the filler material 32a is arranged at a position closer to the base end of the cylinder 11 than the filler material 32b. The plurality of reinforcement members 20 may be fixed in the cylinder 11 by sandwiching the plurality of reinforcement members 20 between the filler material 32a and the filler material 32b in the axial direction of the cylindrical portion 10.

Similarly, in the cylinder 12, the filler material 32c is arranged at a position closer to the base end of the cylinder 12 than a filler material 32d. The plurality of reinforcement members 20 may be fixed in the cylinder 12 by sandwiching the plurality of reinforcement members 20 between the filler material 32c and the filler material 32d in the axial direction of the cylindrical portion 10. Similarly, in the cylinder 13, a filler material 32e is arranged at a position closer to the base end of the cylinder 13 than a filler material 32f. The plurality of reinforcement members 20 may be fixed in the cylinder 13 by sandwiching the plurality of reinforcement members 20 between the filler material 32e and the filler material 32f in the axial direction of the cylindrical portion 10.

According to the present modification example, even in the case in which a plurality of cylinders are connected, the plurality of reinforcement members 20 are arranged at the internal space of each of the cylinders 11, 12, 13 in the region at the base end of each of the cylinders 11, 12, 13. Therefore, it is possible to effectively increase the rigidity of the cylindrical portion 10. Further, since the plurality of reinforcement members 20 are arranged in a concentrated manner in the partial region at the base end of each of the cylinders 11, 12, 13, it is possible to reduce the use amount of the plurality of reinforcement members 20, and shorten the carrying-in step of carrying the plurality of reinforcement members 20 into the cylindrical portion 10.

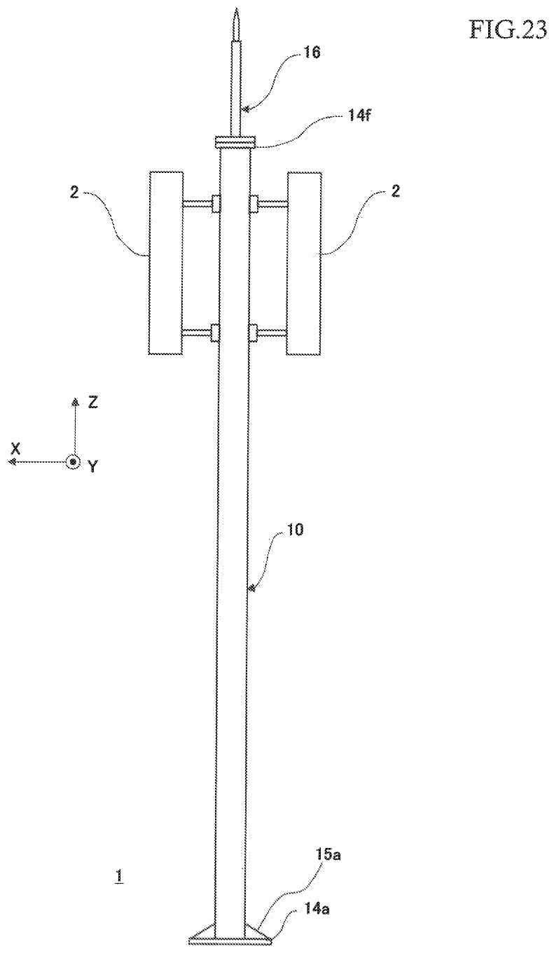

FIG. 23 is a view showing a modification example of the column body for antenna support. In the first to eighth embodiments, the cylindrical portion 10 is arranged with the cylinder 11, the cylinder 12, and the cylinder 13 having different diameters communicating with each other. However, the present invention can also be applied to the antenna support pole 1 having the cylindrical portion 10 including one cylinder instead of a plurality of cylinders as shown in FIG. 23.

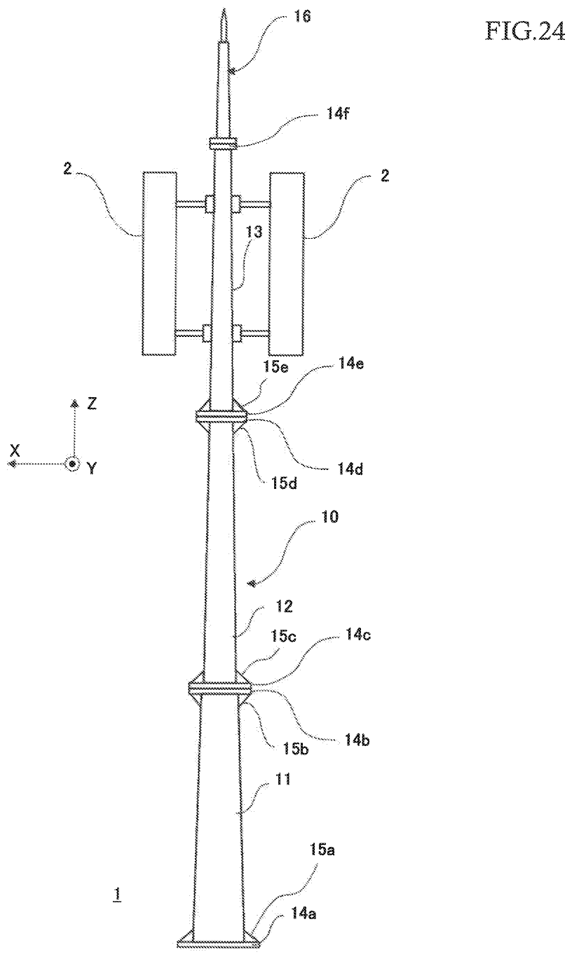

FIG. 24 is a view showing a modification example of the column body for antenna support. In the first to eighth embodiments, the inner diameter and the outer diameter of each of the cylinder 11, the cylinder 12, and the cylinder 13 having different diameters are constant regardless of the position in the axial direction, but the present invention is not limited thereto. At least one of the cylinder 11, the cylinder 12, and the cylinder 13 may be configured such that the diameter thereof is decreased toward the positive direction (upward) along the Z-axis direction. In the present example, in each of the cylinders 11, 12, 13, the diameter thereof is decreased toward the positive direction (upward) along the Z-axis direction. The present invention can be applied to such a variety of cylindrical portions 10.

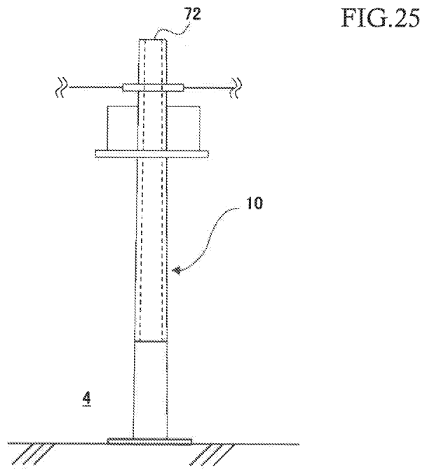

FIG. 25 is a view showing an example of a power pole 4 for power transmission. The power pole 4 is another example of the column body which is the structure of the present invention. The power pole 4 has the cylindrical portion 10 formed of concrete and steel frame or the like. Therefore, the rigidity can be enhanced by supplying the reinforcement members 20 from the opening 72 at the end of the cylindrical portion 10 and arranging and fixing the reinforcement members 20 in the cylindrical portion 10. The configurations of the reinforcement members 20 and the fixing portion 30 may be the same as those described with reference to FIGS. 1 to 24. Therefore, detailed description thereof will be omitted.

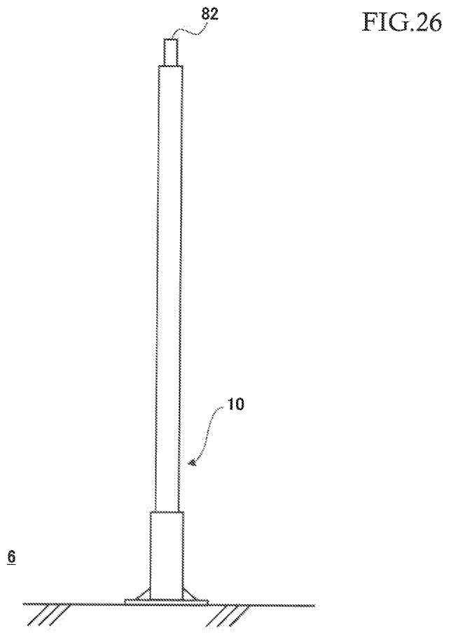

FIG. 26 is a view showing an example of a street lamp pole 6. The street lamp pole 6 is another example of the column body which is the structure of the present invention. The street lamp pole 6 is provided with a street lamp. The street lamp pole 6 has the cylindrical portion 10 formed of metal. Therefore, the rigidity can be enhanced by supplying the reinforcement members 20 from the opening 82 at the end of the cylindrical portion 10 and arranging and fixing the reinforcement members 20 in the cylindrical portion 10. The configurations of the reinforcement members 20 and the fixing portion 30 may be the same as those described with reference to FIGS. 1 to 24. Therefore, detailed description thereof will be omitted. In particular, in the street lamp pole 6, the rigidity of the cylindrical portion 10 is low as compared with the antenna support pole 1. Therefore, even when the reinforcement members 20 each including the base material 22 formed of foamed synthetic resin as shown in FIG. 4A is used, the effect of sufficiently improving rigidity can be obtained.

In the above, description has been provided on the case in which the structure of the present invention is a cylindrical body including the cylindrical portion 10. However, the structure of the present invention is not limited to the case of the cylindrical body. The structure of the present invention may be configured with the plurality of reinforcement members 20 as described above arranged in the main body portion of the structure.

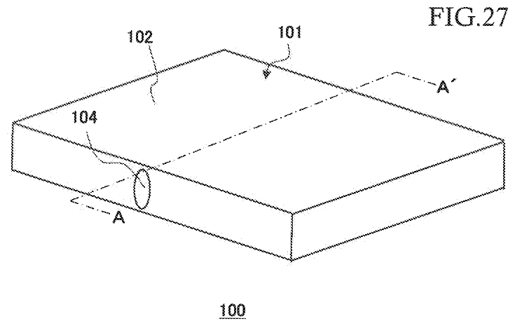

FIG. 27 is a perspective view showing an example of a structure 100 in a ninth embodiment of the present invention. The structure 100 includes a main body portion 101. In the present example, the main body portion 101 has a hollow configuration surrounding an internal space. In the present example, the main body portion 101 has a rectangular parallelepiped shape, but the main body portion 101 is only required to have a hollow configuration and is not limited to a rectangular parallelepiped shape.

The main body portion 101 may include an outer shell portion 102 and a cover portion 104. The cover portion 104 closes an opening formed at a part of the outer shell portion 102 of the main body portion 101. The main body portion 101 may be formed of at least one material selected from the group consisting of metal, ceramic, wood, and resin. The outer shell portion 102 and the cover portion 104 of the main body portion 101 may be formed of the same material, or may be formed of different materials. The outer shell portion 102 and the cover portion 104 may be joined by welding or the like. Further, the outer shell portion 102 may be configured of a plurality of components as a first outer shell portion and a second outer shell portion. In this case, the hollow configuration is formed by joining the plurality of components to each other by welding or the like. The cover portion 104 may also serve as at least one fixing portion 30 which fixes the plurality of reinforcement members 20 into the main body portion 101. In this case, only with the cover portion 104 of the main body portion 101, the fixing portion 30 is not required to be separately arranged.

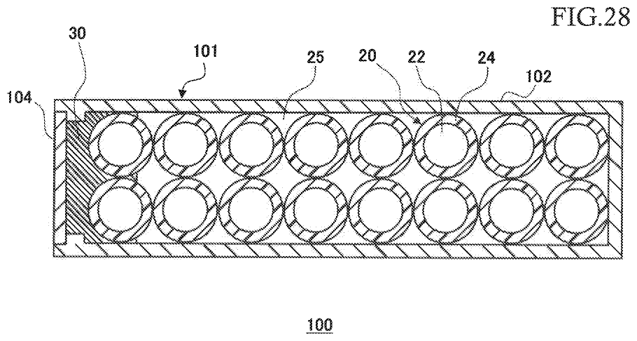

FIG. 28 is a sectional view showing an example of a cross-section of the structure 100 shown in FIG. 27. The structure 100 includes a plurality of reinforcement members 20 arranged in the main body portion 101. In the present example, the main body portion 101 has a hollow configuration surrounding an internal space thereof. The plurality of reinforcement members 20 are arranged at the internal space.

The main body portion 101 includes at least one fixing portion 30 which fixes the plurality of reinforcement members 20 into the main body portion 101. In the present example, the fixing portion 30 may be a filler material which is filled in at least a part of the inside of the hollow configuration so as to be in contact with at least some reinforcement members 20 among the plurality of reinforcement members 20 and an inner surface of the hollow configuration. The filler material may be similar to the filler material 32 described in the first to fifth embodiments shown in FIGS. 1 to 12. Therefore, detailed description of the filler material will be omitted. On the other hand, as described with reference to FIGS. 15 and 16, the fixing portion 30 may include a connection portion having a side surface connected to an inner surface of the hollow configuration and an extension portion extending from a main surface of the connection portion along an extension direction of the hollow configuration. The connection portion and the extension portion may be similar to the connection portion 33 and the extension portion 34 in FIGS. 15 and 16. The extension direction of the hollow configuration may be a direction intersecting with the main surface of the connection portion.

In the present example, the space 25 between the adjacent reinforcement members 20 at the internal space may be unfilled except for the region filled with the filler material. The configuration of the structure 100 of the present example may be similar to the configuration in the first to eighth embodiments described with reference to FIGS. 1 to 26 except that the hollow configuration of the structure 100 is not the cylindrical portion 10. Therefore, description thereof will not be repeated.

The manufacturing method of the structure 100 of the present embodiment includes a preparation step, a carrying-in step, and a step of arranging the fixing portion 30 for fixing the plurality of reinforcement members 20 into the main body portion 101. In the preparation step, the plurality of reinforcement members 20 are prepared. In the carrying-in step, the plurality of reinforcement members 20 are carried into the internal space from the opening arranged in the main body portion 101. The step of arranging the fixing portion 30 may include a filling step. In the filling step, the filler material for fixing the plurality of reinforcement members 20 into the main body portion 101 may be filled into at least a part of the internal space. The opening may be blocked by the cover portion 104. The outer shell portion 102 and the cover portion 104 may be joined by welding or the like. Here, the manufacturing method of the structure 100 may not necessarily include the filling step. The positions of the plurality of reinforcement members 20 may be fixed by blocking the opening with the cover portion 104 which functions as the fixing portion 30.

As in the present embodiment, even when the structure 100 is not a cylindrical body, the rigidity of the hollow configuration can be enhanced. By arranging the plurality of reinforcement members 20 at the internal space of the main body portion 101 having the hollow configuration, the coating layer 24 formed of polyurea resin generates the similar configuration as a mesh configuration in the internal space. Thus, it is considered that the rigidity of the structure 100 is increased. Here, the coating layer 24 formed of polyurea resin may be omitted, and the plurality of reinforcement members 20 each including the base material formed of fiber reinforced resin (FRP) may be arranged at the internal space of the structure 100.

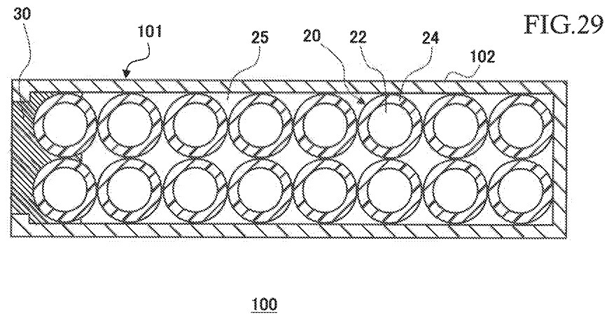

FIG. 29 is a sectional view showing an example of the structure 100 in a tenth embodiment of the present invention. In the ninth embodiment shown in FIGS. 27 and 28, description has been provided on the case in which the main body portion 101 includes the outer shell portion 102, the cover portion 104, and the fixing portion 30, but the present invention is not limited thereto. As shown in FIG. 29, the cover portion 104 may not be arranged. In the present example, the fixing portion 30 closes the opening of the main body portion 101. The fixing portion 30 is, for example, the filler material formed of polyurea resin.

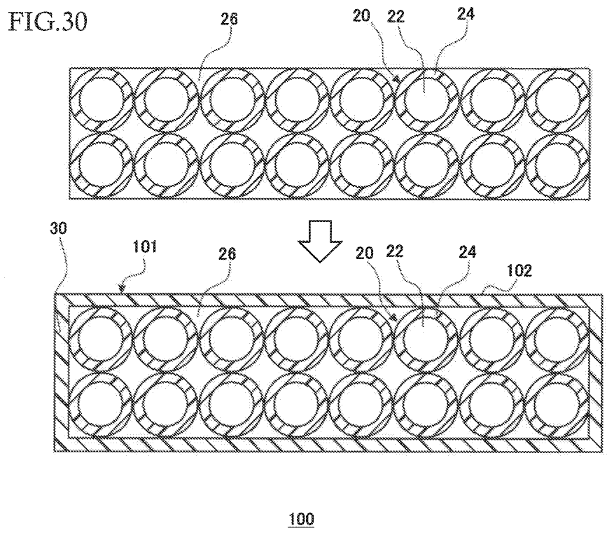

FIG. 30 is a sectional view showing an example of the structure 100 in an eleventh embodiment of the present invention. The upper stage of FIG. 30 shows a state before the outer shell portion 102 is arranged, and the lower stage of FIG. 30 shows a state after the outer shell portion 102 is arranged.

In the present embodiment, the main body portion 101 may include at least one material selected from the group consisting of metal, ceramic, wood, and resin. The outer shell portion 102 of the main body portion 101 has a hollow configuration surrounding the internal space. The main body portion 101 has a foamed synthetic resin 26 at the internal space. The plurality of reinforcement members 20 are embedded in the foamed synthetic resin 26 at the internal space. In other words, a region other than the plurality of reinforcement members 20 at the internal space is filled with the foamed synthetic resin 26.

The manufacturing method of the structure 100 of the present embodiment may include a preparation step and a step of forming the main body portion 101. In the preparation step, the plurality of reinforcement members 20 are prepared. The reinforcement members 20 may be similar to those in the first to tenth embodiments. The manufacturing method includes the step of forming the main body portion 101 by molding a material of the main body portion 101 such that the plurality of reinforcement members 20 are embedded therein. In the present example, the main body portion 101 may be formed such that the plurality of reinforcement members 20 are embedded in the foamed synthetic resin 26 (foamed synthetic resin for the main body portion) forming a part of the main body portion 101. Specifically, a technique of insert molding may be used. Note that, instead of the foamed synthetic resin 26, other resin, concrete, or the like may be used as a material arranged at the internal space.

Then, after the foamed synthetic resin 26 for the main body portion 101 is molded, the outer surface of the molded foamed synthetic resin 26 is covered with the outer shell portion 102. The manufacturing method of the structure 100 in the present example may include a main body portion application step of applying polyurea resin to the outside of the foamed synthetic resin 26 for the main body portion 101. Thus, the outer shell portion 102 can be formed of polyurea resin. Here, the outer shell portion 102 may be formed by a method other than applying. In one example, the outer shell portion 102 may be configured of a plurality of components as a first outer shell portion and a second outer shell portion. The first outer shell portion and the second outer shell portion may be joined with a method such as welding in a state in which the molded foamed synthetic resin 26 is sandwiched between the first outer shell portion and the second outer shell portion.

According to the present example, it is possible to omit the carrying-in step of carrying the plurality of reinforcement members 20 into the internal space. Further, when the outer shell portion 102 is formed by applying polyurea resin to the outside of the foamed synthetic resin 26 for the main body portion 101, it is not necessary to arrange the opening for carrying-in the plurality of reinforcement members 20 to the internal space of the main body portion 101, and it is not necessary to arrange the cover portion 104 for closing the opening. Therefore, it is possible to improve the sealing property of the structure 100. Since the outer shell portion 102 can be formed of polyurea resin, it is possible to realize the structure 100 which is excellent in weight reduction and corrosion resistance.

The structure 100 may not necessarily have a hollow configuration. The present invention is simply required to have a configuration in which the plurality of reinforcement members 20 are arranged as each including the base material 22 described above and the coating layer 24 formed of polyurea resin and the plurality of reinforcement members 20 are arranged in the main body portion 101, and is not necessarily limited to the structure 100 having a hollow configuration.

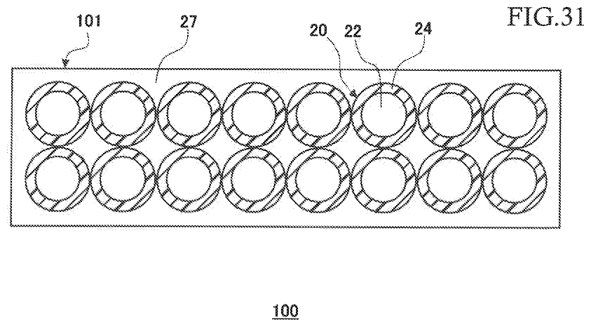

FIG. 31 is a sectional view showing an example of the structure 100 in a twelfth embodiment of the present invention. In the present example, the main body portion 101 does not include the outer shell portion 102 and the cover portion 104. The main body portion 101 is formed by molding a material 27 of the main body portion 101 into the shape of the main body portion 101. The material 27 of the main body portion 101 may be resin or concrete. The plurality of reinforcement members 20 are embedded in the material 27 of the main body portion 101.

The manufacturing method of the structure 100 of the present embodiment may be similar to the preparation step and the step of forming the main body portion 101 in the eleventh embodiment shown in FIG. 30. The manufacturing method may include the step of forming the main body portion 101 by molding the material 27 of the main body portion 101 such that the plurality of reinforcement members 20 are embedded therein.

In the present example as well, unlike the case in which the structure 100 is configured only by the main body portion 101, the plurality of reinforcement members 20 each including polyurea resin as the coating layer 24 are arranged in the main body portion 101, so that the rigidity of the structure 100 can be increased.

The structures 100 shown in the ninth to twelfth embodiments shown in FIGS. 27 to 31 can be used for various products. Examples in which the structures 100 are used for various products will be described below.

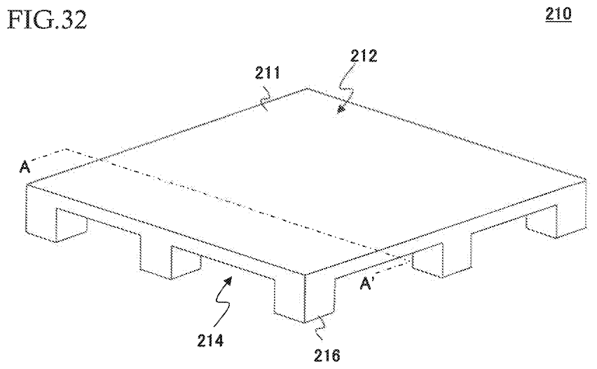

FIG. 32 is a perspective view showing an example of a pallet 210 in a thirteenth embodiment of the present invention. The pallet 210 is an example of the structure 100. The pallet 210 allows articles to be placed thereon. The pallet 210 is used, for example, in physical distribution, and is used for storing and transporting articles.

The pallet 210 of the present example includes a pallet main body 211 and a plurality of legs 216. The pallet main body 211 of the present example has a plate shape. In the pallet main body 211, a surface on which an article is placed is referred to as a placement surface 212, and a surface opposite to the placement surface 212 is referred to as a back surface 214.

The plurality of legs 216 are arranged on the back surface 214. The plurality of legs 216 may be formed integrally with the pallet main body 211 or may be bonded to the pallet main body 211. The respective legs 216 are arranged at predetermined intervals. It is preferable that the legs 216 are arranged in a grid manner so that a fork of a forklift or the like can pass between the legs 216.

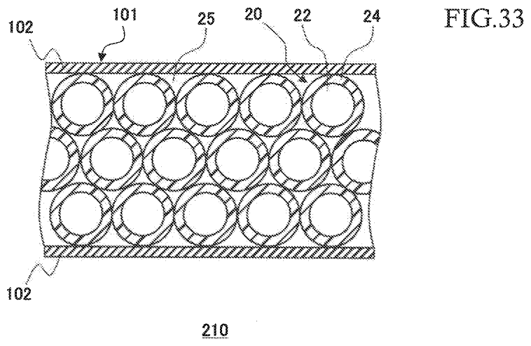

FIG. 33 is a view showing a partial cross-section of the pallet 210 shown in FIG. 32. FIG. 33 shows a cross-section of a part of the main body portion 101. The pallet 210 may include the main body portion 101. Specifically, the main body portion 101 may include the outer shell portion 102 formed of a material selected from the group consisting of metal, ceramic, wood, and resin. The outer shell portion 102 may be formed of polyurea resin. The plurality of reinforcement members 20 are arranged at the internal space surrounded by the outer shell portion 102. The plurality of reinforcement members 20 each include the base material 22 and the coating layer 24. The space 25 may be filled with foamed synthetic resin or may not be filled. Other configurations of the pallet 210 of the present embodiment may be similar to those of any structure 100 of the eighth to eleventh embodiments shown in FIGS. 27 to 31.

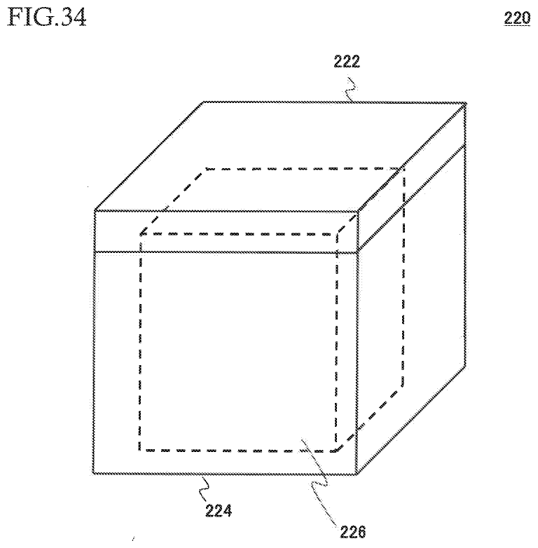

FIG. 34 is a perspective view showing an example of a box body 220 in a fourteenth embodiment of the present invention. The box body 220 has a storage space 226. The box body 220 of the present example has a storage portion 224 and a lid portion 222. A recess serving as the storage space 226 is formed in the storage portion 224. The lid portion 222 is placed on the storage portion 224 to seal the storage space 226. It is also possible that the lid portion 222 is fixed to the storage portion 224 by a part of the lid portion 222 being inserted to the storage space 226. The box body 220 is used as, for example, a cold insulation box for storing fresh food and the like, but the use application of the box body 220 is not limited thereto. Other configurations of the box body 220 of the present embodiment may be similar to those of any of the structures 100 in the ninth to twelfth embodiments shown in FIGS. 27 to 31.

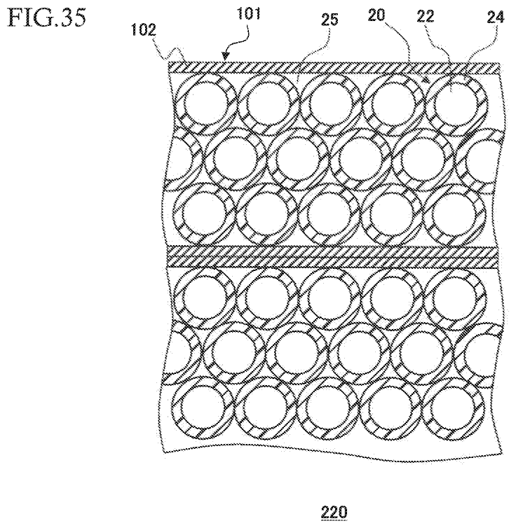

FIG. 35 is a view showing a partial cross-section of the lid portion 222 and the storage portion 224 shown in FIG. 34. Similarly to the pallet 210 shown in FIG. 33, the lid portion 222 and the storage portion 224 may each include the main body portion 101. Specifically, the main body portion 101 may include the outer shell portion 102 formed of a material selected from the group consisting of metal, ceramic, wood, and resin. In particular, the outer shell portion 102 may be formed of polyurea resin. The plurality of reinforcement members 20 are arranged at the internal space surrounded by the outer shell portion 102. The plurality of reinforcement members 20 each include the base material 22 and the coating layer 24. The space 25 may be filled with foamed synthetic resin or may not be filled. Other configurations of the box body 220 of the present embodiment may be similar to those of any of the structures 100 in the ninth to twelfth embodiments shown in FIGS. 27 to 31.

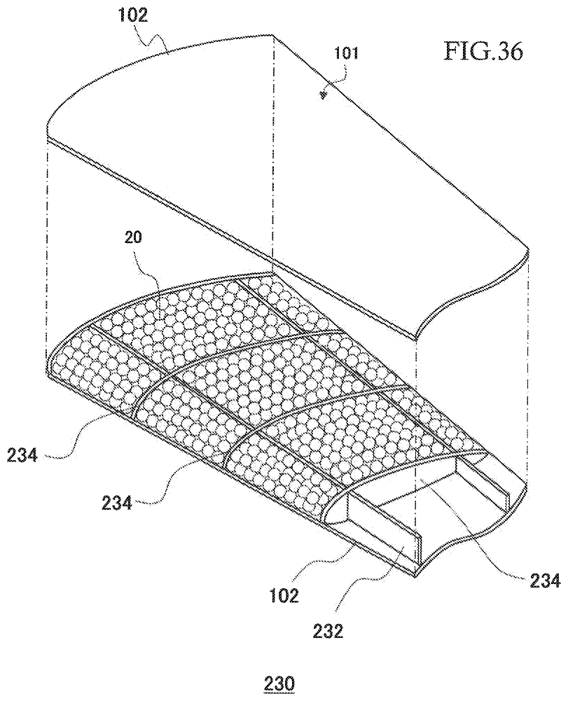

FIG. 36 is a view showing an example of an airframe 230 of an aircraft in a fifteenth embodiment of the present invention. The aircraft may be a manned or unmanned aircraft. The airframe 230 of the aircraft is an example of the structure 100. In the present example, a main wing portion is shown as the airframe 230. The airframe 230 may include upper and lower outer shell portions 102 as the main body portion 101. The main body portion 101 is formed by joining the upper and lower outer shell portions 102. Beam portions 232 and rib portions 234 may be arranged at the internal space of the main body portion 101. The plurality of reinforcement members 20 are arranged at the internal space. The plurality of reinforcement members 20 each include the base material 22 and the coating layer 24. The plurality of reinforcement members 20 may be fixed to the main body portion 101 by a filler material.

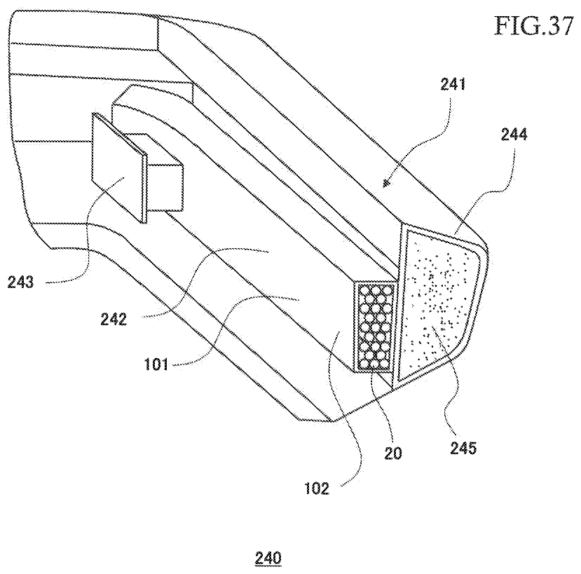

FIG. 37 is a view showing an example of a component of a vehicle in a sixteenth embodiment of the present invention. In the present example, a bumper 240 is shown as a component of a vehicle. The bumper 240 of the present example may include an impact absorbing portion 241 for absorbing an impact, a beam portion 242, and an attachment portion 243. The impact absorbing portion 241 may include an exterior portion 244 and a resin material 245. The exterior portion 244 and the resin material 245 may be integrally formed.

The beam portion 242 of the bumper 240 of the vehicle is an example of the structure 100. The beam portion 242 includes the main body portion 101. The main body portion 101 has a hollow configuration surrounding an internal space thereof. The main body portion 101 may include an outer shell portion 102 formed of a material selected from the group consisting of metal, ceramic, wood, and resin. In the present example, the outer shell portion 102 is formed in a cylindrical shape having a rectangular cross-section. The plurality of reinforcement members 20 are arranged at the internal space.

The beam portion 242 may be arranged along the rear side of the impact absorbing portion 241. The beam portion 242 and the impact absorbing portion 241 may be connected to each other. The attachment portion 243 is arranged at the beam portion 242. The bumper 240 may be connected to the frame of the vehicle via the attachment portion 243.

In the example of FIG. 37, description has been provided on the case of applying the structure of the present invention to the beam portion 242, but the present invention is not limited thereto. In one example, the structure of the present invention may be applied as well to the impact absorbing portion 241. The structure of the present invention can be applied not only to the bumper 240 but also to various components such as exterior components or interior components of a vehicle such as an automobile or a train.

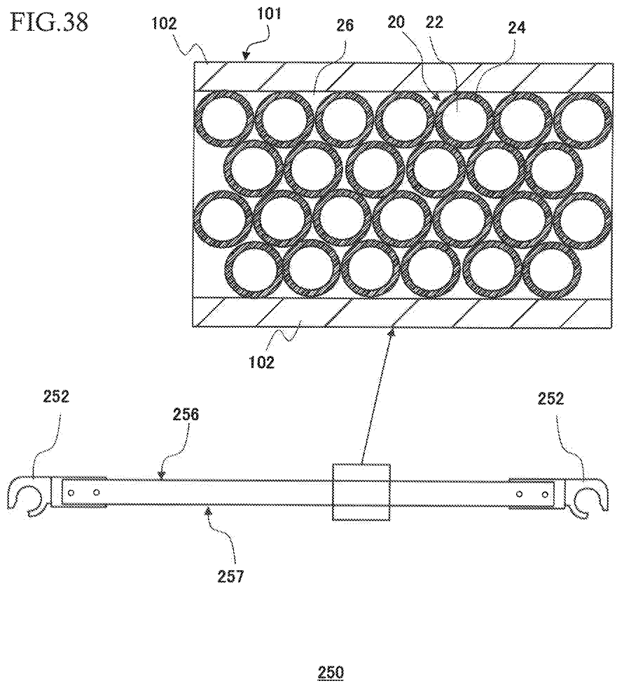

FIG. 38 is a view showing an example of a scaffold plank 250 for construction in a seventeenth embodiment of the present invention. FIG. 38 also shows a partially enlarged cross-section of a side surface portion of the scaffold plank 250 for the sake of description. The scaffold plank 250 is an example of the structure 100. The scaffold plank 250 has the main body portion 101. The main body portion 101 may include an outer shell portion 102 formed of a material selected from the group consisting of metal, ceramic, wood, and resin. In particular, the outer shell portion 102 may be a polyurea resin layer. The outer shell portion 102 is formed in a cylindrical shape having a rectangular cross-section. The plurality of reinforcement members 20 are arranged at the internal space surrounded by the outer shell portion 102. At the internal space, a region other than the plurality of reinforcement members 20 may be filled with the foamed synthetic resin 26.

The manufacturing method of the scaffold plank 250 of the present embodiment may be similar to the manufacturing method of the structure in FIG. 30. The manufacturing method may include the step of forming the main body portion 101 by molding a material of the main body portion 101 such that the plurality of reinforcement members 20 are embedded therein. The manufacturing method may include a main body portion application step of applying polyurea resin on the outer surface of the molded foamed synthetic resin 26 for the main body portion 101 after the foamed synthetic resin 26 is molded. Thus, the outer shell portion 102 can be formed of polyurea resin.

To secure the scaffold plank 250 to an external scaffolding structure, both ends of the scaffold plank 250 may be provided with hook members 252 formed of metal or reinforced plastic. As an example, the hook member 252 may be attached to the scaffold plank 250 via a connection member which cramps and is fixed to a front surface 256 and a back surface 257 of the scaffold plank 250 formed of foamed synthetic resin. In this case, the polyurea resin layer may cover the connection member from the above.

According to such a configuration, it is possible to provide the scaffold plank 250 with increased rigidity while achieving weight reduction.

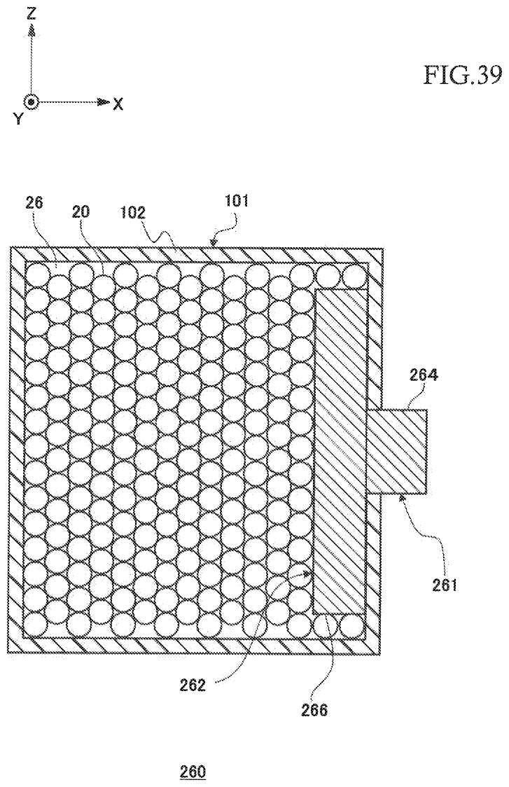

FIG. 39 is a view showing an example of a panel 260 as a building material in an eighteenth embodiment of the present invention. The panel 260 may be a building material for a house. The panel 260 may be an exterior wall material of a house, a floor material of a house, or an interior material of a house. The panel 260 is an example of the structure 100.

The external shape of the panel 260 of the present example may be a plate shape. However, the external shape of the panel 260 is not limited thereto. The panel 260 includes the main body portion 101 having a hollow configuration. The main body portion 101 may include an outer shell portion 102 formed of a material selected from the group consisting of metal, ceramic, wood, and resin. In particular, the outer shell portion 102 may be a polyurea resin layer. In the present example, the outer shell portion 102 is formed as a hollow configuration having a rectangular cross-section. The plurality of reinforcement members 20 are arranged at the internal space surrounded by the outer shell portion 102. At the internal space, gaps other than the reinforcement members 20 may be filled with the foamed synthetic resin 26. However, the foamed synthetic resin 26 may not be filled thereto.

The panel 260 of the present example may include a fastening portion 261. The fastening portion 261 may connect the panel 260 to another member or another panel 260. The fastening portion 261 may be formed of metal, reinforced plastic, wood, or the like. The fastening portion 261 may be an insertion portion providing connection by being inserted into an insertion hole formed in another member or another panel 260. In this case, the insertion portion may be provided with a stopper mechanism for locking the insertion portion in the insertion hole so as not to come out of the inserted insertion hole. Alternatively, the fastening portion 261 may be a male screw. Not limited specifically to the above, any of various fastening mechanisms can be employed as the fastening mechanism of the fastening portion 261.

One end 262 of the fastening portion 261 is embedded in the main body portion 101. Another end 264 of the fastening portion 261 is exposed from the main body portion 101. The one end 262 of the fastening portion 261 may have a bent portion 266. The bent portion 266 is a portion extending in a direction intersecting with a direction extending from one end 262 to the other end 264 of the fastening portion 261. The bent portion 266 can function as an anchor portion which prevents the fastening portion 261 from coming out of the main body portion 101. Here, not limited to have the fastening portion 261, the panel 260 may not have the fastening portion 261.

The manufacturing method of the panel 260 of the present embodiment may be similar to the manufacturing method of the structure in FIG. 30. The manufacturing method may include the step of forming the main body portion 101 by molding a material of the main body portion 101 such that the plurality of reinforcement members 20 and the one end 262 of the fastening portion 261 are embedded therein. The manufacturing method may include a main body portion application step of applying polyurea resin on the outer surface of the molded foamed synthetic resin 26 for the main body portion 101 after the foamed synthetic resin 26 is molded. Thus, the outer shell portion 102 can be formed of the polyurea resin. According to the panel 260 as a building material of the present embodiment, it is possible to increase the rigidity while achieving weight reduction.

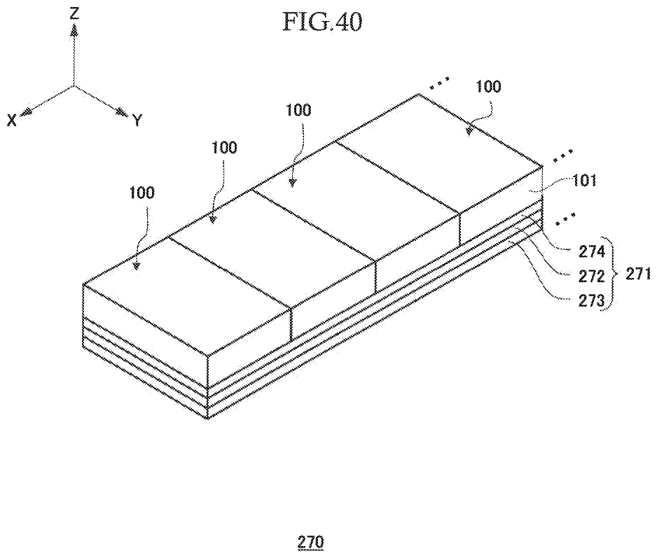

FIG. 40 is a view illustrating an example of an impact absorbing member 270 in a nineteenth embodiment of the present invention. The impact absorbing member 270 may be cut into an appropriate size according to an object and attached to the surface of the object whose impact resistance is to be increased. For example, the impact absorbing member 270 is affixed on the surface of a moving device. Examples of the moving device include various devices such as vehicles, in-hospital moving support systems, electric carts for the elderly, and golf carts.

Further, the impact absorbing member 270 may be affixed on the inner surface or the outer surface of a box body such as a container. The impact absorbing member 270 may be affixed to the bottom surface or the front surface of footwear such as slippers. The impact absorbing member 270 may be affixed to the surface of a wearing article such as a helmet. However, the object to which the impact absorbing member 270 is affixed is not limited to these moving devices, box bodies, footwear, and wearing articles.

The impact absorbing member 270 may include an adhesive tape portion 271 and the structure 100. The adhesive tape portion 271 includes a tape body 272, a first adhesive layer 273, and a second adhesive layer 274. The first adhesive layer 273 is an adhesive layer applied on one surface of the tape body 272, and serves as an adhesive surface for affixing the impact absorbing member 270 to an object. The second adhesive layer 274 fixes the adhesive tape portion 271 and the structure 100 to each other. The tape body 272 may be formed of a flexible material. A plurality of the structures 100 may be arranged on one adhesive tape portion 271, or one structure 100 may be arranged thereon. Not limited to the arrangement shown in FIG. 40, a plurality of the structures 100 may be arranged on the adhesive tape portion 271 two-dimensionally along the XY plane. Thus, a user can cut out and use the impact absorbing member 270 in a necessary range.

The configuration of the structure 100 may be similar to that of any of the structures 100 in the ninth to twelfth embodiments shown in FIGS. 27 to 31. Therefore, description thereof will not be repeated. Receiving input of use application of the impact absorbing member 270, the elasticity of the coating layer 24 may be changed in accordance with the use application. In one example, each use application and the content ratio between “diethyltoluenediamine” which is a constituent solution of an amine solution and “diphenylmethane diisocyanate” which is a constituent solution of an isocyanate solution may be stored as table data, and a computer may determine the content ratio with reference to the table data.

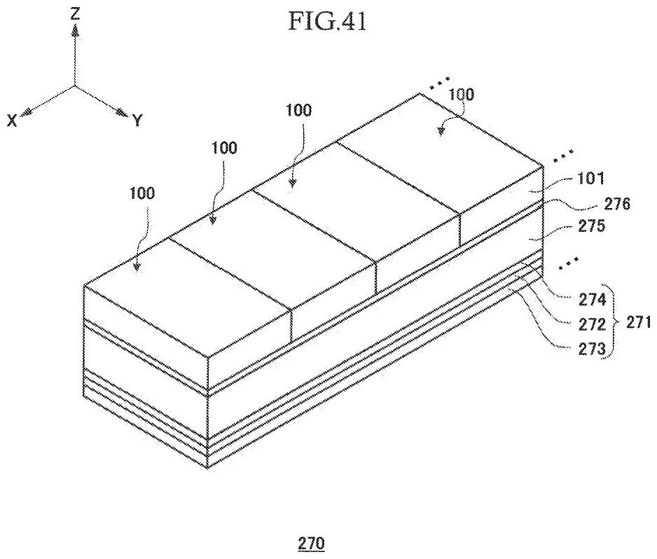

FIG. 41 is a view showing another example of the impact absorbing member 270. In the present example, a base member 275 is added to the impact absorbing member 270 shown in FIG. 40. The base member 275 is laminated on the adhesive tape portion 271. In the present example, the base member 275 is laminated on the upper surface of the adhesive tape portion 271. Specifically, the base member 275 is fixed to the adhesive tape portion 271 by the second adhesive layer 274 of the adhesive tape portion 271. The base member 275 may include one or more types of materials selected from the group consisting of foamed synthetic resin, carbon fibers, polyamide-based synthetic fibers, silicate fibers, basalt fibers, an inorganic material powder highly-blended thin film sheet, and cellulose nanofibers.

When the base member 275 is foamed synthetic resin, synthetic resin which forms the base member 275 may be a polymer compound. As a more specific example, synthetic resin forming the base member 275 is formed of one or more materials selected from polystyrene, polyethylene, polypropylene, and polyurethane. Foamed synthetic resin refers to synthetic resin described above in which fine bubbles are dispersed. In one example, the base member 275 is formed of foamed styrene (foamed polystyrene). One or more of the structures 100 described above are arranged on the base member 275. The base member 275 and the structure 100 may be bonded by a third adhesive layer 276.

As shown in the present example, the structure of the present invention may also be used as a part of a composite material laminated on another base member 275.

Although the impact absorbing member 270 has been described with reference to FIGS. 40 and 41, the structures shown in FIGS. 40 and 41 may be a corrosion inhibitor or a thermal insulator.

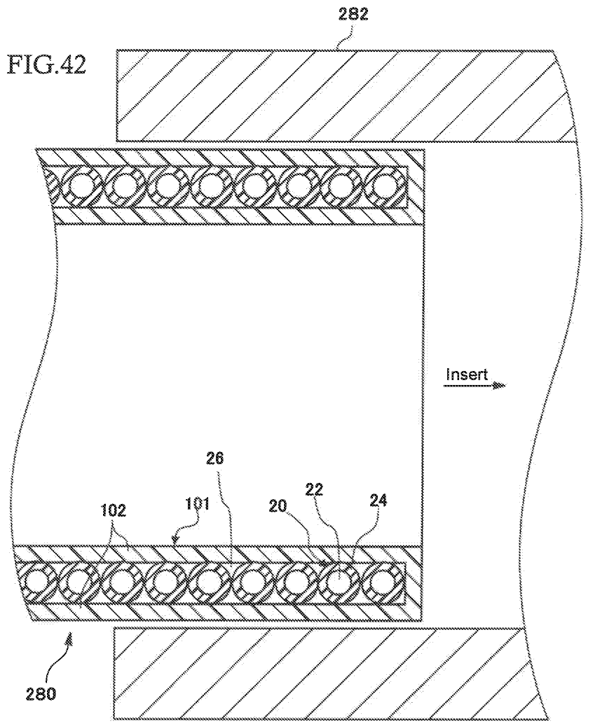

FIG. 42 is a sectional view showing an example of a pipe body 280 in a twentieth embodiment of the present invention. The pipe body 280 of the present example is inserted as a new pipe into an aged existing pipe 282. The existing pipe 282 may be an existing water pipe or another pipe. The existing pipe 282 functions as a sheath pipe. The pipe body 280 is an example of the structure 100.

The outer shape of the pipe body 280 may be a cylindrical shape. The pipe body 280 has the main body portion 101. The main body portion 101 may include an outer shell portion 102 formed of a material selected from the group consisting of metal, ceramic, and resin. In particular, the outer shell portion 102 may be a polyurea resin layer. The outer shell portion 102 is a hollow member surrounding a hollow space. Thus, the portion of the pipe body 280 having an annular cross-section is formed as a hollow configuration rather than a solid configuration. The plurality of reinforcement members 20 are arranged at the internal space surrounded by the outer shell portion 102. At the internal space, gaps other than the reinforcement members 20 may be filled with the foamed synthetic resin 26. However, the foamed synthetic resin 26 may not be filled thereto.

The manufacturing method of the pipe body 280 of the present embodiment may be similar to the manufacturing method of the structure in FIG. 30. The manufacturing method may include the step of forming the main body portion 101 by molding the foamed synthetic resin 26 for the main body portion 101, which is the material of the main body portion 101, into a pipe shape such that the plurality of reinforcement members 20 are embedded therein. The manufacturing method may include a main body portion application step of applying polyurea resin on the outer surface of the molded foamed synthetic resin 26 for the main body portion 101 after the foamed synthetic resin 26 is molded into a pipe shape. Thus, the outer shell portion 102 can be formed of polyurea resin. According to the pipe body 280 of the present embodiment, it is possible to increase the rigidity while achieving weight reduction.

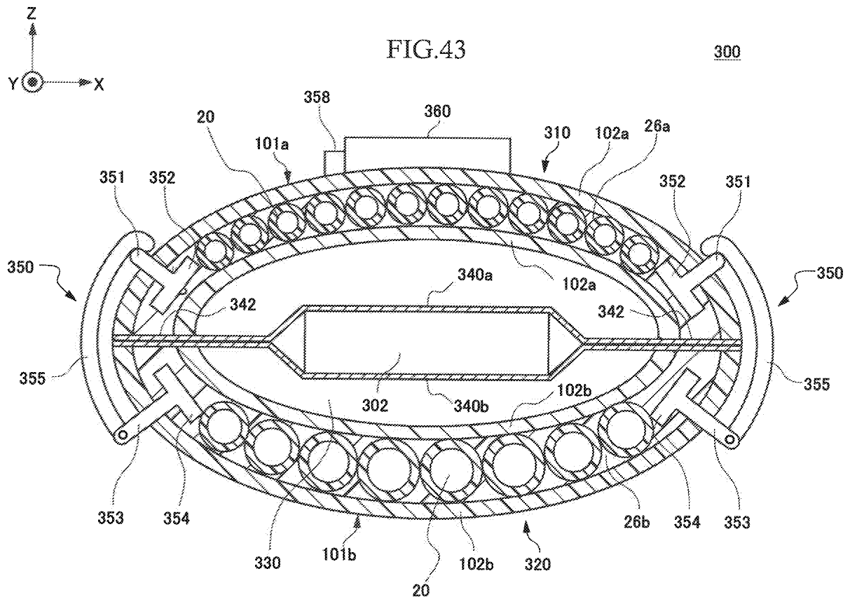

FIG. 43 is a sectional view showing an example of a packaging container 300 in a twenty-first embodiment of the present invention. A packaging container 300 packs an object to be packaged 302. In particular, the packaging container 300 may be airborne and dropped from the sky to be delivered to a destination. The object to be packaged 302 is not particularly limited, but is suitable for air transportation of pharmaceuticals and the like such as various vaccines.

The packaging container 300 includes a first container half body 310, a second container half body 320, and at least one pair of films 340. The open ends of the first container half body 310 and the second container half body 320 are closed as being abut against each other to form a container (310, 320). In the present example, the first container half body 310 and the second container half body 320 are combined to form an accommodation space 330. Note that the first container half body 310 and the second container half body 320 may not necessarily have the same size.

The container (310, 320) of the present example has a spheroidal shape (prolate spheroid shape) in which the major axis is the axis of rotation as a whole. That is, the container (310, 320) has a rugby ball shape. In the present example, the container (310, 320) may be divided into the first container half body 310 and the second container half body 320 in the plane of separation along the major axis.

In the container (310, 320) of the present example, the first container half body 310 and the second container half body 320 are examples of the structure 100, respectively. The first container half body 310 has a main body portion 101a. The main body portion 101a may include an outer shell portion 102a formed of a material selected from the group consisting of metal, ceramic, and resin. In particular, the outer shell portion 102a may be a polyurea resin layer. The plurality of reinforcement members 20 are arranged at the internal space surrounded by the outer shell portion 102a. The plurality of reinforcement members 20 may include reinforcement members 20 having different sizes. At the internal space, gaps other than the reinforcement members 20 may be filled with the foamed synthetic resin 26a.

The second container half body 320 has the main body portion 101. The main body portion 101 may include an outer shell portion 102b. The plurality of reinforcement members 20 are arranged at the internal space surrounded by the outer shell portion 102b. At the internal space, gaps other than the reinforcement members 20 may be filled with the foamed synthetic resin 26b.

The pair of films 340 include a first film 340a and a second film 340b. The first film 340a is fixed in a stretched state along the open end of the first container half body 310. The second film 340b is fixed in a stretched state along the open end of the second container half body 320.

The first film 340a and the second film 340b are fixed to be faced to each other in a state in which the first film 340a and the second film 340b are stretched in the accommodation space 330 formed in the container (310, 320). The packaging container 300 of the present embodiment holds the object to be packaged 302 between the pair of films 340. The object to be packaged 302 may be sandwiched between a pair of films 340 in a state of being further wrapped with a cushioning material.

The packaging container 300 may have a coupling portion 350. The coupling portion 350 couples the first container half body 310 and the second container half body 320. The coupling portion 350 of the present example includes a protrusion portion 351, a support portion 353, and a clamp portion 355. One end of the protrusion portion 351 may be embedded in the main body portion 101a of the first container half body 310, and the other end thereof may protrude outward from the surface. The one end of the protrusion portion 351 of the present example has a bent portion 352 which is bent in the main body portion 101a so as not to be easily pulled out. One end of the support portion 353 is embedded in the main body portion 101b of the second container half body 320, and the clamp portion 355 is rotatably connected to the other end thereof. The clamp portion 355 is fixed by being fitted with the protrusion portion 351. The one end of the support portion 353 has a bent portion 354 which is bent in the main body portion 101b so as not to be easily pulled out. Here, the coupling portion 350 is not particularly limited as long as it couples the first container half body 310 and the second container half body 320.

One end of the container (310, 320) may be provided with a parachute portion 360 which reduces the falling speed of the packaging container 300 when the packaging container 300 falls from the sky. Further, the packaging container 300 may be arranged with a GPS transmitter 358.

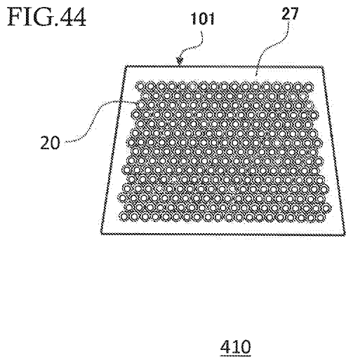

FIG. 44 is a sectional view showing an example of a rail tie 410 for railroad in a twenty-second embodiment of the present invention. In the present example, the rail tie 410 for railroad formed of prestressed concrete (PS concrete) is shown. However, the rail tie 410 may have a plate shape having a trapezoidal cross-section. The rail tie 410 is an example of the structure 100.

The rail tie 410 of the present example may not have the outer shell portion 102. The main body portion 101 is formed by molding a material 27 of the main body portion 101 into the shape of the main body portion 101. The material 27 of the main body portion 101 may be concrete. The plurality of reinforcement members 20 are embedded in the material 27 of the main body portion 101.

The manufacturing method of the structure 100 of the present embodiment may include a preparation step and a step of forming the main body portion 101. In the preparation step, the plurality of reinforcement members 20 are prepared. The reinforcement members 20 may be similar to those in the first to tenth embodiments. The manufacturing method includes the step of forming the main body portion 101 by molding the material 27 of the main body portion 101 such that the plurality of reinforcement members 20 are embedded therein. In this example, concrete which is the material 27 of the main body portion 101 is poured into a mold. At that time, the reinforcement members 20 are arranged in the mold so that the plurality of reinforcement members 20 are embedded in the material 27. Specifically, a technique of insert molding may be used.

According to the present example, the rigidity of the rail tie 410 can be increased, the material of the concrete to be used can be saved, and weight reduction can be achieved. In the example shown in FIG. 44, description has been provided on the case in which the outer shell portion 102 is not provided similarly to the structure 100 shown in FIG. 31, but the rail tie 410 is not limited thereto. The configuration and manufacturing method similar to those of the structure 100 in the eighth to twelfth embodiments shown in FIGS. 27 to 31 can be applied to the rail tie 410. In other words, the main body portion 101 of the rail tie 410 may be formed of at least one material selected from the group consisting of metal, ceramic, wood, and resin.

Further, the rail tie 410 may include the main body portion 101 having a hollow configuration surrounding the internal space.

Although the present invention has been described above using the embodiments, the technical scope of the present invention is not limited to the embodiments described above. It will be apparent to those skilled in the art that various modifications and improvements can be made to the embodiments described above. It is also apparent from the scope of the claims that the embodiments added with such modifications or improvements are also included in the technical scope of the present invention.

It should be noted that the order of execution of processes, such as operations, procedures, steps, and stages in the devices, systems, programs, and methods described in the claims, specification, and figures may be implemented in any order unless otherwise specified as “before”, “prior to”, or the like, and unless otherwise an output of a previous process is used in a later process. Even if operation flow in the claims, specification, or drawings is described using “first”, “next”, and the like for convenience, it does not mean that the operation flow is necessarily performed in the order.

### REFERENCE SIGNS LIST

1 Antenna support pole
2 Antenna
4 Power pole
6 Street lamp pole
10 Cylindrical portion
11 Cylinder
12 Cylinder
13 Cylinder
14 Flange portion
15 Rib
16 Lightning rod
17 Side surface
18 Main surface
20 Reinforcement member
21 Reinforcement member
22 Base material
24 Coating layer
25 Space
26 Foamed synthetic resin
27 Material
30 Fixing portion
32 Filling material
33 Connection portion
34 Extension portion
41 Region
42 Region
43 Region
51 External reinforcement portion
52 External reinforcement portion
54 External reinforcement portion
55 Cover portion
62 Supply unit
64 Nozzle
66 Nozzle
72 Opening
82 Opening
90 Carrying-in device
91 Storage tank
92 Supply pipe
93 Motor
94 Alignment supply device
95 Conveyance pipe
96 Blower
97 Control unit
100 Structure
101 Main body portion
102 Outer shell portion
104 Cover portion
210 Pallet
211 Pallet main body
212 Placement surface
214 Back surface
216 Leg
220 Box body
222 Lid portion
224 Storage portion
226 Storage space
230 Airframe
232 Beam portion
234 Rib
240 Bumper
241 Impact absorbing portion
242 Beam portion
243 Attachment portion
244 Exterior portion
245 Resin material
250 Scaffold plank
252 Hook member
256 Front surface
257 Back surface
260 Panel
261 Fastening portion
262 One end
264 Other end
266 Bent portion
270 Impact absorbing member
271 Adhesive tape portion
272 Tape body
273 First adhesive layer
274 Second adhesive layer
275 Base member
276 Third adhesive layer
280 Pipe body
282 Existing pipe
300 Packaging container
302 Object to be packaged
310 First container half body
320 Second container half body
330 Accommodation space
340 Film
350 Coupling portion
351 Protrusion portion
352 Bent portion
353 Support portion
354 Bent portion
355 Clamp portion
358 GPS transmitter
360 Parachute portion
410 Rail tie

1-83. (canceled)

84. A structure, comprising:
a main body portion having a hollow configuration surrounding an internal space thereof; and
a plurality of reinforcement members arranged at the internal space of the main body portion, each of the reinforcement members including a base material formed of resin or metal and a coating layer which is formed of polyurea resin and which covers an outer surface of the base material.

85. The structure according to claim 84,
wherein the main body portion includes a cylindrical portion as the hollow configuration, and
the plurality of reinforcement members are arranged in the cylindrical portion.

86. The structure according to claim 84,
wherein the main body portion includes at least one fixing portion which fixes the plurality of reinforcement members into the main body portion,
the internal space is separated into a plurality of regions by the fixing portion, and
elasticity of the coating layers of the plurality of arranged reinforcement members is different in correspondence to the separated regions.

87. The structure according to claim 84, wherein
the main body portion includes at least one fixing portion which fixes the plurality of reinforcement members into the main body portion,
the fixing portion includes a filler material which is filled in at least a part of the inside of the hollow configuration so as to be in contact with at least some reinforcement members among the plurality of reinforcement members and an inner surface of the hollow configuration,
the filler material includes polyurea resin, and
the polyurea resin included in the filler material has higher viscosity than polyurea resin in the coating layer.

88. The structure according to claim 84,
wherein the main body portion is an antenna support pole which supports an antenna.

89. The structure according to claim 84,
wherein the main body portion is a power pole which supports a power transmission line or a telephone pole which supports a communication line.

90. The structure according to claim 84,
wherein the main body portion is a street lamp pole to which a street lamp is attached.

91. The structure according to claim 84,
wherein the main body portion is a pallet on which an article is placed.

92. The structure according to claim 84,
wherein the main body portion is a box body having a space therein.

93. The structure according to claim 84,
wherein the main body portion is an airframe of a manned or unmanned aircraft.

94. The structure according to claim 84,
wherein the main body portion is a component of a vehicle.

95. The structure according to claim 84,
wherein the main body portion is a scaffold plank for construction.

96. The structure according to claim 84,
wherein the main body portion is a panel as a building material, and
the structure further includes a fastening portion with one end embedded in the main body portion and the other end exposed therefrom.

97. The structure according to claim 84,
wherein the main body portion is an impact absorbing member, a corrosion inhibitor, or a thermal insulator.

98. The structure according to claim 84,
wherein the main body portion is a pipe body to be inserted as a new pipe into an aged existing pipe.

99. The structure according to claim 84,
wherein the main body portion is a container to be used as a packaging container.

100. The structure according to claim 84,
wherein the main body portion is a rail tie for railroad.

101. A reinforcement member, comprising:
a base material formed of resin or metal; and
a coating layer which is formed of polyurea resin and which covers an outer surface of the base material,
a plurality of the reinforcement members being arranged in a structure so as to reinforce the structure.

102. A manufacturing method of a structure which includes a main body portion having a hollow configuration surrounding an internal space thereof, the manufacturing method comprising:
preparing a plurality of reinforcement members each including a base material formed of resin or metal and a coating layer which is formed of polyurea resin and which covers an outer surface of the base material; and
carrying the plurality of reinforcement members into the internal space from an opening arranged at the main body portion.

103. The manufacturing method of the structure according to claim 102, further comprising pressing the plurality of reinforcement members into the internal space.
